(19) United States
(12) Patent Application Publication
(10) Pub. No.: US 2026/0153424 A1
(43) Pub. Date: Jun. 4, 2026

(54) SYSTEMS AND METHODS FOR ISOLATING PARTICLES IN SOLUTION BY PARTICLE PERMITTIVITY

(71) Applicant: SIGIL BIOSCIENCES, INC., Del Mar, CA (US)

(72) Inventors: Iryna CLARK, Del Mar, CA (US); Rajaram KRISHNAN, Del Mar, CA (US)

(21) Appl. No.: 19/102,016

(22) PCT Filed: Aug. 8, 2023
(86) PCT No.: PCT/US2023/071873

§ 371 Date: Feb. 7, 2025

Related U.S. Application Data
(60) Provisional application No. 63/370,701, filed on Aug. 8, 2022.

(51) Int. Cl. G01N 15/02; G01N 1/40; G01N 15/01; G01N 15/10; G01N 15/12

(52) U.S. Cl. CPC G01N 15/0266; G01N 1/40; G01N 15/01; G01N 15/12; G01N 2001/4038; G01N 2015/1006; G01N 2015/135

(57) ABSTRACT

Provided herein are systems and methods of electrohydrodynamic isolation of one or more particles of varying size and dielectric properties.

### CROSS-REFERENCE

This application is a U.S. National Stage entry of PCT Application No. PCT/US2023/071873, filed Aug. 8, 2023, which claims the benefit of U.S. Provisional Patent Application No. 63/370,701 filed Aug. 8, 2022, which is entirely incorporated by reference herein.

### BACKGROUND

Cell-derived and synthetic particles have been commercially used in life science for multiple applications e.g., drug discovery, disease biomarkers, drug nanocarriers, and others. These particles may be naturally occurring or engineered and can be characterized as, for example: cells, extracellular vesicles, cell-death bodies and synthetic nanovesicles or coated particles. Technological advancements in the field of particle manipulation and related applications are needed to further improve efficiencies of drug discovery or diagnostic development platforms.

### SUMMARY

The disclosure provided herein describes methods, devices, and/or systems to isolate one or more particles and/or one or more plurality of particles in complex fluids with minimal artifact (e.g., isolating only target particles with minimal accompanying particles not intended to be isolated). The methods described and implemented in by the systems and devices, described elsewhere herein, may be referred to as a D.A.S.H. method. In some cases, D.A.S.H. may describe a dielectric (D), alternating current (A), strictive(S), hydrodynamic (H) method of altering a permittivity of one or more particles and/or one or more plurality of particles. The disclosure provided herein describes methods, devices and/or systems that may manipulate the relative permittivity of one or more particles and/or one or more plurality of particles suspended in a solution. By increasing the relative permittivity of the one or more particles and/or one or more plurality of particles, methods, devices, and/or systems such as those disclosed herein may isolate, separate, sort, capture, and/or elute the one or more particles and/or the one or more plurality of particles using electrostrictive hydrodynamic forces.

In an aspect the disclosure describes a method of isolating particles, the method comprising: (a) providing a fluid composition comprising the particles, wherein the particles comprise a plurality of first particles and a plurality of second particles, wherein the plurality of first particles and the plurality of second particles have the same or different sizes; (b) providing a device comprising at least one chip, the at least one chip comprising at least one electrode and at least one substrate, the at least one electrode and at least one substrate being configured to produce an electric field on or around the substrate when a current is applied to the at least one electrode; (c) providing the fluid composition to the device; (d) applying a first frequency to a first location on the at least one chip to isolate the plurality of first particles at the first location; and (e) applying a second frequency to a second location on the at least one chip to isolate the plurality of second particles at the second location. In some embodiments, the device comprises a microfluidic device. In some embodiments, the method further comprises, after step (c), selecting each of the first frequency and the second frequency that is specific to the plurality of first particles or the plurality of second particles. In some embodiments, the method further comprises, after isolation in step (d) or (e), conducting an on-chip analysis of the plurality of first particles or the plurality of second particles. In some embodiments, the on-chip analysis comprises confirming the presence or absence of the plurality of first particles or the plurality of second particles. In some embodiments, the on-chip analysis comprises quantifying the plurality of first particles or the plurality of second particles. In some embodiments, the method further comprises, after isolation in step (d) or (e), eluting the plurality of first particles or the plurality of second particles for a downstream processing and/or analysis. In some embodiments, the method further comprises, after eluting the plurality of first particles or the plurality of second particles, repeating steps (a)-(d) or (a)-(e) to further fractionate and/or separate a third plurality of particles. In some embodiments, each of the first frequency and the second frequency is generated by using an electro strictive hydrodynamic force. In some embodiments, the electro strictive hydrodynamic force comprises electrophoretic force, electrokinetic force, interfacial polarization, electro strictive force, alternating current (AC) electrothermal force, or a combination thereof. In some embodiments, the first frequency and the second frequency are applied simultaneously or sequentially. In some embodiments, the first frequency and the second frequency are applied simultaneously. In some embodiments, the first frequency and the second frequency are applied sequentially. In some embodiments, the first frequency and the second frequency are different. In some embodiments, the first frequency and the second frequency are below about 100 kHz. In some embodiments, the first frequency and the second frequency are below about I MHz. In some embodiments, the first frequency and the second frequency are between about I kHz and about I 00 kHz. In some embodiments the first frequency and the second frequency are between about I 00 Hz and about I MHz. In some embodiments, the first frequency and the second frequency are between about 1 MHz and about 20 MHz. In some embodiments, applying the first frequency or the second frequency increases a membrane permittivity of the plurality of first particles or the plurality of the second particles having sizes less than about 1.8 μm. In some embodiments, the method further comprises modifying a membrane permittivity of the plurality of first particles or the plurality of second particles having sizes greater than about 1.8 μm. In some embodiments, the method further comprises modifying a membrane permittivity of the plurality of first particles or the plurality of second particles to increase the difference in the membrane permittivity of the plurality of first particles or the plurality of second particles and a surrounding media. In some embodiments, the modification comprises introducing an integral membrane structure having a high dielectric constant (e.g., at least about 100,000 relative permittivity when measured at 1 kHz using Equation 2 or at least about 1000 when measured at I kHz using traditional methods) to a surface of the plurality of first particles or the plurality of second particles. In some embodiments, the integral membrane structure comprises a protein or a lipid. In some embodiments, the modification comprises introducing a transmembrane structure having a high dielectric constant, as described elsewhere herein, to a surface of the plurality of first particles or the plurality of second particles. In some embodiments, the transmembrane structure comprises a protein, lipid, or a combination thereof. In some embodiments, the modification comprises coating a surface of the plurality of first particles or the plurality of second particles with a coating polymer having a high dielectric constant, as described elsewhere herein. In some embodiments, the coating polymer is a synthetic polymer or a conjugated polymer. In some embodiments, the coating polymer comprises a biopolymer, a naturally occurring polymer, or a combination thereof. In some embodiments, the coating polymer is synthetic biopolymer, where the synthetic biopolymer is comprised of a synthesized copy of a biopolymer. In some embodiments, the coating polymer comprises a conjugated polymer. In some embodiments, the modification comprises coating a surface of the plurality of first particles or the plurality of second particles with a ceramic having a high dielectric constant, as described elsewhere herein. In some embodiments, the ceramic is a micro-ceramic. In some embodiments, the modification comprises attaching a plurality of nanoparticles to a surface of the plurality of first particles or the plurality of second particles. In some embodiments, the plurality of nanoparticles comprises sizes between about 1 nm and about 200 nm, where the size comprises a diameter of the plurality of nanoparticles. In some embodiments, the plurality of nanoparticles comprises synthetic particles. In some embodiments, the plurality of nanoparticles comprises biological particles. In some embodiments, the plurality of first particles and/or the plurality of second particles comprise membrane-bound particles. In some embodiments, the membrane-bound particles are polarizable at frequencies below about 1 MHz.

In some embodiments, the membrane-bound particles comprise a phospholipid membrane-containing particle. In some embodiments, the phospholipid membrane-containing particle comprises a cell, an organelle, a vesicle, a micelle, exomeres, exosomes, microvesicles, ectosomes, migrasomes, oncosomes, a cell death body, or any combination thereof. In some embodiments, the cells comprise red blood cells, white blood cells, circulating tumor cells, circulated endothelial cells, or any combination thereof. In some embodiments, organelles may comprise the nucleus, endoplasmic reticulum, golgi apparatus, vacuoles, lysosomes, mitochondria, or any combination thereof. In some embodiments, the phospholipid membrane-containing particle comprise a virus, bacteria, or a combination thereof. In some embodiments, the vesicle comprises a nanovesicle. In some embodiments, the membrane-bound particles comprise a metal. In some embodiments, the metal comprises gold, silver, platinum, copper, or any combination thereof. In some embodiments, the membrane-bound particles comprise a metal oxide. In some embodiments, the membrane-bound particles comprise a glass, e.g., borosilicate glass, silica beads, silicon dioxide, silicon nitride, rubber (both natural and/or silicone), or any combination thereof. In some embodiments, the membrane-bound particles comprise a rubber such as natural or silicone rubber. In some embodiments, the membrane-bound particles comprise a polymer. In some embodiments, the polymer comprises naturally occurring polymers, such as proteins, carbohydrates, lipids, nucleic acids, or any combination thereof. In some embodiments, the polymer is a synthetic polymer or a conjugated polymer. In some embodiments, the polymer comprises polystyrene, polyethylene, poly(ethylene glycol) (PEG), or any combination thereof. In some embodiments, the polymer comprises a conjugated polymer such as PVDF co-polymers, PARQ co-polymers (e.g., HO-PAQR and RO-PAQR, etc.), cuPc, FePc, PTTEMA/PS, Polythiourea blends, polymer and ceramic composites, polymer and metal composites, polymers with hyperbranched structures, or any combination thereof. In some embodiments, the membrane-bound particles comprise a ceramic. In some embodiments, the membrane-bound particles comprise a coated particle. In some embodiments, the plurality of first particles and/or the plurality of second particles are fully coated. In some embodiments, the plurality of first particles and/or the plurality of second particles are partially coated. In some embodiments, the coated particles exhibit high dielectric constants, as described elsewhere herein. In some embodiments, the membrane-bound particles comprise a membrane that is bound to a surface of the plurality of first particles or the plurality of second particles via a covalent bond. In some embodiments, the membrane-bound particles comprise a membrane that is bound to a surface of the plurality of first particles or the plurality of second particles via a non-covalent bond.

In some embodiments, an ionic strength of a medium of the fluid composition comprises greater than about 0.1 mM. In some embodiments, the ionic strength of a medium of the fluid composition comprises an ionic strength of less than about 10 mM. In some embodiments, the ionic strength of a medium of the fluid composition comprises an ionic strength of between about 0.1 mM and about 10 mM. In some embodiments, the ionic strength of a medium of the fluid composition comprises an ionic strength greater than about 10 mM. In some embodiments, the first location and the second location overlap or do not overlap. In some embodiments, the device comprises an inlet configured to receive the fluid composition. In some embodiments, the device comprises an outlet configured to output the isolated first plurality of particles and the second plurality of particles. In some embodiments, the first frequency comprises a first frequency range and the second frequency comprises a second frequency range. In some embodiments, the method further comprises providing a washing solution to the surface of the chip, wherein the washing solution is configured to remove particles from the device that are not isolated on the at least one electrode. In some embodiments, the method further comprises reversing the modification of the membrane permittivity of the first plurality of particles or the second plurality of particles, where reversing is completed by heat, enzyme, or any combination thereof. In some embodiments, the at least one electrode comprises a first electrode and a second electrode. In some embodiments, the first electrode or the second electrode comprise a carrier electrode or a sink electrode. In some embodiments, the first plurality of particles and the second plurality of particles are isolated and eluted sequentially. In some embodiments, the first plurality of particles and the second plurality of particles are isolated simultaneously and eluted sequentially. In some embodiments, the first plurality of particles and the second plurality of particles are isolated and eluted simultaneously. In some embodiments, the fluid composition comprises the first plurality of particles and the second plurality of particles suspended in a complex solution. In some embodiments, the exosome's and/or the vesicle's origin are indicative of a disease, where the disease comprises Alzheimer's, Parkinson's, traumatic brain injury, or any combination thereof. In some embodiments, the first plurality of particles or the second plurality of particles comprise nucleic acid molecules, proteins, or a combination thereof. In some embodiments, the first plurality of particles or the second plurality of particles comprise DNA, RNA, a fragment of DNA, a fragment of RNA, or any combination thereof.

Aspects of the disclosure provided describe a method of isolating particles, the method comprising: (a) providing a fluid composition comprising one or more particles, wherein the one or more particles comprise the same or different size (e.g., same or different diameter); (b) modifying a membrane permittivity of the one or more particles; (c) providing a device comprising at least one chip, the at least one chip comprising at least one electrode and at least one substrate, the at least one electrode and the at least one substrate being configured to produce an electric field on or around the at least one substrate when a current is applied to the at least one electrode; (d) providing the fluid composition to the device; and (e) isolating the one or more particles based on the permittivity of the particles. In some embodiments, the method further comprises, after isolating in (e), (f) eluting the one or more particles for a downstream processing and/or analysis. In some embodiments, the method further comprises, after (f), repeating steps (a)-(e) or (a)-(f). In some embodiments, the device comprises a microfluidic device. In some embodiments, the one or more particles comprise a plurality of first particles and a plurality of second particles. In some embodiments, the plurality of first particles and the plurality of second particles have different sizes or the same size. In some embodiments, the method further comprises applying a first frequency to a first location on the at least one chip to isolate the plurality of first particles at the first location. In some embodiments, the method further comprises applying a second frequency to a second location on the at least one chip to isolate the plurality of second particles at the second location. In some embodiments, the method further comprises, after step (d), selecting each of the first frequency and the second frequency that is specific to the plurality of first particles or the plurality of second particles. In some embodiments, the method further comprises, after isolation in step (e), conducting an on-chip analysis of the plurality of first particles or the plurality of second particles. In some embodiments, the on-chip analysis comprises confirming the presence or absence of the plurality of first particles or the plurality of second particles. In some embodiments, the on-chip analysis comprises quantifying the plurality of first particles or the plurality of second particles. In some embodiments, the method further comprises, after isolation in step (e), eluting the plurality of first particles or the plurality of second particles for a downstream analysis. In some embodiments, each of the first frequency and the second frequency is generated using an electrostrictive hydrodynamic force. In some embodiments, the electrostrictive hydrodynamic force comprises electrophoretic force, electrokinetic force, interfacial polarization, electrostrictive force, alternating current (AC) electrothermal force, or any combination thereof. In some embodiments, the first frequency and the second frequency are applied simultaneously or sequentially. In some embodiments, the first frequency and the second frequency are applied simultaneously. In some embodiments, the first frequency and the second frequency are applied sequentially. In some embodiments, the first frequency and the second frequency are different. In some embodiments, the first frequency and the second frequency are below about 100 kHz. In some embodiments, the first frequency and the second frequency are below about 1 MHz. In some embodiments, the first frequency and the second frequency are between about 1 kHz and about 100 kHz. In some embodiments, the first frequency and the second frequency are between about 100 Hz and about 1 MHz. In some embodiments, the first frequency and the second frequency are between about 1 MHz and about 20 MHz. In some embodiments, the sizes of the first particles and the second particles are different. In some embodiments, modifying the membrane permittivity of the plurality of first particles or the plurality of second particles increases the difference in a membrane permittivity of the plurality of first particles or the plurality of second particles and a surrounding media. In some embodiments, modifying the membrane permittivity of the plurality of first particles or the plurality of second particles comprises introducing an integral membrane structure having a high dielectric constant to a surface of the plurality of first particles or the plurality of second particles. In some embodiments, the integral membrane structure comprises a protein, lipid, or a combination thereof. In some embodiments, modifying the membrane permittivity of the plurality of first particles or the plurality of second particles comprises introducing a transmembrane structure having a high dielectric constant to a surface of the plurality of first particles or the plurality of second particles. In some embodiments, the transmembrane structure comprises a protein, lipid, or combination thereof. In some embodiments, modifying the membrane permittivity of the plurality of first particles or the plurality of second particles comprises coating a surface of the plurality of first particles or the plurality of second particles with a polymer having a high dielectric constant. In some embodiments, the polymer comprises a biopolymer, a naturally occurring polymer, or a combination thereof. In some embodiments, the polymer is a synthetic polymer or a conjugated polymer. In some embodiments, the synthetic biopolymer is comprised of a synthesized copy of a biopolymer. In some embodiments, the polymer is a conjugated polymer. In some embodiments, modifying the membrane permittivity of the plurality of first particles or the plurality of second particles comprises coating a surface of the plurality of first particles or the plurality of second particles with a ceramic having a high dielectric constant. In some embodiments, the ceramic is a micro-ceramic. In some embodiments, modifying the membrane permittivity of the plurality of first particles or the plurality of second particles comprises attaching a plurality of nanoparticles to a surface of the plurality of first particles or the plurality of second particles. In some embodiments, the size (e.g., diameter) of the plurality of nanoparticles comprises between about 1 nm and about 200 nm. In some embodiments, the plurality of nanoparticles is synthetic particles. In some embodiments, the plurality of nanoparticles is biological particles. In some embodiments, the plurality of first particles and/or the plurality of second particles comprise membrane-bound particles. In some embodiments, the membrane-bound particles are highly polarizable at frequencies below 1 MHz. In some embodiments, the membrane-bound particles comprise a phospholipid membrane-containing particle. In some embodiments, the phospholipid membrane-containing particle comprises a cell, an organelle, a vesicle, a micelle, exomers, exomes, microvesicles, ectosomes, migrasomes, oncosomes, a cell death body, or any combination thereof. In some embodiments, the vesicle comprises a nanovesicle. In some embodiments, the cells comprise red blood cells, white blood cells, circulating tumor cells, circulated endothelial cells, or any combination thereof. In some embodiments, organelles may comprise the nucleus, endoplasmic reticulum, golgi apparatus, vacuoles, lysosomes, mitochondria, or any combination thereof. In some embodiments, the phospholipid membrane-containing particle comprise a virus, bacteria, or a combination thereof. In some embodiments, the vesicle comprises a nanovesicle. In some embodiments, the membrane-bound particles comprise a metal. In some embodiments, the metal comprises gold, silver, platinum, copper, or any combination thereof. In some embodiments, the membrane-bound particles comprise a metal oxide. In some embodiments, the membrane-bound particles comprise a polymer. In some embodiments, the polymer comprises polystyrene, polyethylene, poly(ethylene glycol) (PEG), or any combination thereof. In some embodiments, the polymer comprises a conjugated polymer such as PVDF co-polymers, PARQ co-polymers (e.g., HO-PAQR and RO-PAQR, etc.), cuPc, FePc, PTTEMA/PS, Polythiourea blends, polymer and ceramic blends, polymer and metal composites, polymers with hyperbranched structures, or any combination thereof. In some embodiments, the membrane-bound particles comprise a ceramic. In some embodiments, the membrane-bound particles comprise a glass such as borosilicate glass, silica beads, silicon dioxide, silicon nitride, rubber (both natural and/or silicone), or any combination thereof. In some embodiments, the membrane-bound particles comprise a rubber such as natural or silicone rubber. In some embodiments, the membrane-bound particles comprise a coated particle. In some embodiments, the coated particles exhibit high dielectric constants. In some embodiments, the membrane-bound particles comprise a membrane that is bound to a surface of the plurality of first particles or the plurality of second particles via a covalent bond. In some embodiments, the membrane-bound particles comprise a membrane that is bound to a surface of the plurality of first particles or the plurality of second particles via a non-covalent bond. In some embodiments, an ionic strength of a medium of the fluid composition comprises an ionic strength greater than 0.1 mM. In some embodiments, the ionic strength of a medium of the fluid composition comprises an ionic strength less than about 10 mM. In some embodiments, the ionic strength of a medium of the fluid composition comprises an ionic strength between about 0.1 mM and about 10 mM. In some embodiments, the ionic strength of a medium of the fluid composition comprises an ionic strength of greater than about 10 mM. In some embodiments, modifying the membrane permittivity comprises modifying a capacitance of the one or more particles. In some embodiments, modifying the membrane permittivity comprises modifying a capacitance of the plurality of first particles and modifying a capacitance of the plurality of second particles. In some embodiments, the first plurality of particles or the second plurality of particles comprises nucleic acid molecules, proteins, or a combination thereof. In some embodiments, the first plurality of particles or the second plurality of particles comprise DNA, RNA, a fragment of DNA, a fragment of RNA, or a combination thereof. In some embodiments, the first location and the second location overlap or do not overlap. In some embodiments, the device comprises an inlet configured to receive the fluid composition. In some embodiments, the device comprises an outlet configured to output the isolated first plurality of particles and the second plurality of particles. In some embodiments, the first frequency comprises a first frequency range and the second frequency comprises a second frequency range. In some embodiments, the method further comprises providing a washing solution to the surface of the chip, wherein the washing solution is configured to remove particles from the device that are not isolated on the at least one electrode. In some embodiments, the method further comprises reversing the modification of the membrane permittivity of the first plurality of particles or the second plurality of particles, where reversing is completed by heat, enzyme, or any combination thereof. In some embodiments, the at least one electrode comprises a first electrode and a second electrode. In some embodiments, the first electrode or the second electrode comprise a carrier electrode or a sink electrode. In some embodiments, the first plurality of particles and the second plurality of particles are isolated and eluted sequentially. In some embodiments, the first plurality of particles and the second plurality of particles are isolated simultaneously and eluted sequentially. In some embodiments, the first plurality of particles and the second plurality of particles are isolated and eluted simultaneously. In some embodiments, the fluid composition comprises the first plurality of particles and the second plurality of particles suspended in complex solution. In some embodiments, the exosome's and/or the vesicle's origin are indicative of a disease, where the disease comprises Alzheimer's, Parkinson's, traumatic brain injury, or any combination thereof.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure” and “FIG.” herein), of which:

FIGS. 1A-1D show example particles, as described in embodiments herein.

FIG. 2 shows an example diagram configuration of a device or system for isolating at least two types of particles from a liquid sample, as described in embodiments herein.

FIG. 3 shows an example diagram configuration of a device or system for isolating at least two types of particles with connected isolating regions, as described in embodiments herein.

FIGS. 4A-4C show various types of membrane permittivity modifiers (MPM) of particles, as described in embodiments herein.

FIG. 5 shows a workflow diagram of a method for isolating particles with modified membrane permittivity, as described in embodiments herein.

FIG. 6 shows a workflow diagram of a method for isolating particles with reversible membrane permittivity modifications, as described in embodiments herein.

FIG. 7 shows a workflow diagram of a method for isolating at least two types of particles with at least two frequencies, as described in embodiments herein.

FIG. 8 shows a computer system that is programmed or otherwise configured to implement methods provided herein, as described in embodiments herein.

FIGS. 9A-9D show data of particle isolation frequencies of one or more particles of varying membrane permittivity in various liquid media, as described in embodiments herein.

FIGS. 10A-10C show example plotted data of the measured capacitance (FIG. 10A), and relative permittivity (FIG. 10B), plotted against electrode frequency for synthetic particles, synthetic particles modified with gold, and gold particles, determined with the methods described herein compared to the traditional approach of predicted permittivity (FIG. 10C), as described in embodiments herein.

FIGS. 11A-11C show example plotted data of the measured capacitance (FIG. 11A), and relative permittivity (FIG. 11B), plotted against electrode frequency for particles (e.g., polystyrene) of the same material but different in size, determined with the methods described herein compared to the traditional approach of predicted permittivity (FIG. 11C), as described in embodiments herein.

FIGS. 12A-12C show example plotted data of the measured membrane and/or surface capacitance (FIG. 12A), and relative permittivity (FIG. 12B), plotted against electrode frequency for unmodified and modified biological particles, determined with the methods described herein compared to the traditional approach of predictive permittivity (FIG. 12C), as described in embodiments herein.

FIGS. 13A-13D show fluorescent images of a microfluidic device with electrodes and a fluid composition of unmodified fluorescent polystyrene beads provided thereto prior to application of electric field (FIG. 13A) and after application of electric field (FIG. 13B); and a fluid composition of polystyrene beads modified with 100 nm Barium Titanate ceramic nanoparticles provided thereto prior to application of electric filed (FIG. 13C) and after application of the electric field (FIG. 13D), as described in some embodiments herein.

FIGS. 14A-14E show fluorescent images of a microfluidic device with electrodes and a fluid composition of unmodified fluorescent polystyrene beads of 500 nm and 4 μm in diameter provided thereto prior to application of an electric field (FIG. 14A), at an electric field voltage and frequency to isolate and/or capture the 500 nm beads (FIG. 14B), a close up of the isolated 500 nm polystyrene beads captured on the electrode shown in FIG. 14B (FIG. 14C), at an electric field voltage and frequency to isolate both the 500 nm and 4 μm polystyrene beads (FIG. 14D), and a close up of the isolated 500 nm polystyrene beads captured on the electrode shown in FIG. 14D (FIG. 14E), as described in some embodiments herein.

### DETAILED DESCRIPTION

Commonly used particle-based isolation methods include ultracentrifugation, density gradient centrifugation, size exclusion chromatography, and polymer-based precipitation. Each of the commonly used particle-based isolations express various shortcomings e.g., ability to isolate a particular target particle (e.g., extracellular vesicles) with minimal contamination from other non-target particles, capability of depleting an isolated sample of lipoproteins and protein contaminates, labor-intensity required to operate a system implementing the method of isolating particles, and cost of performing the assay involved with the method. Other challenges with the commonly used particle-based isolation methods may include isolating particles with a high abundance of serum proteins, such as albumin and globulins, and non-extracellular vesicle lipid particles e.g., chylomicrons and lipoprotein particles that interfere with particle counts.

Electrofluidic particle isolation systems and methods have recently emerged as an alternative to the commonly used particle-based isolation methods. These methods provide a solution to isolate bulk biological material suspended in media, by altering the conductivity of the media with respect to the conductivity of the biological particles. Such techniques have been widely utilized since the conductivity of media can readily be modified. Additionally, it can be understood that the conductivity of the media has a greater influence over the dielectric force exhibited by particles as compared to difference in particle permittivity as shown in the real-component of Clausius-Mossotti (Re[CM)]) (Equation 1). However, since these methods cannot differentiate between membrane-bound and non-membrane bound particles that have the same size, isolation results in presence of artifacts that limits the utility of these methods when determining and/or analyzing insights from specific vesicle population.

The methods, devices, and/or systems described herein operate by applying electrohydrodynamic forces at one or more frequencies (e.g., less than about 20 MHz) to isolate membrane-bound particles suspended in a fluid media based on differences in permittivity (i.e., dielectric constant) between the membrane-bound particles. Permittivity (i.e., dielectric constant) is the ability of a material to store a charge, or the degree to which a medium resists the flow of electric charge. In some instances, this can be due to the material/medium's polarizability, and in other instances this can be due to large electrical charge difference between two surfaces of the material/medium. For example, it could be understood that the dielectric constant of a particle placed in an electric field with a frequency of less than about 20 MHz is a function of the frequency experienced by the particle. By utilizing one or more frequencies in a range of up to about 1 MHz, the relative permittivity of particles is maximized. Particles that are less than about 500 nm in diameter can also have their relative permittivity be a function of the frequency in a range up to 20 MHz depending on their size and material. By altering the permittivity of particles, the methods, devices, and/or systems, described elsewhere herein, produce an unexpected effect of positive attractive force to isolate particles in view of the real component of the Clausius-Mossotti (Re[CM)]) (Equation 1) that ordinarily suggests a negligible effect of force on the particles by a difference in particle permittivity (εₚᵣ) to media permittivity (εₘᵣ) (multiplied to the permittivity of free space squared

$$( {ε}_{0}^{2} ) of \sim {10}^{- 23}$$

compared to the difference in conductivity of media (σₘ) to the particle (σₚ).

$$[ {ω}^{2} {ε}_{0}^{2} ( {ε}_{pr} - {ε}_{mr} ) ( {ε}_{pr} + 2 {ε}_{mr} ) + ( {σ}_{p} - {σ}_{m} ) ( {σ}_{p} - 2 {σ}_{m} ) ] \qquad ( Equation 1 )$$

ω is frequency (in radians), ω=2π*f (frequency in Hertz),
εₚᵣ is relative permittivity of the particle, εₘᵣ is relative permittivity of media,
ε₀=permittivity of free space (8.85×10^{-12 F/m)}. ε₀²=7.84×10⁻²³,
σₚ=conductivity of the particle, and σₘ=conductivity of the media

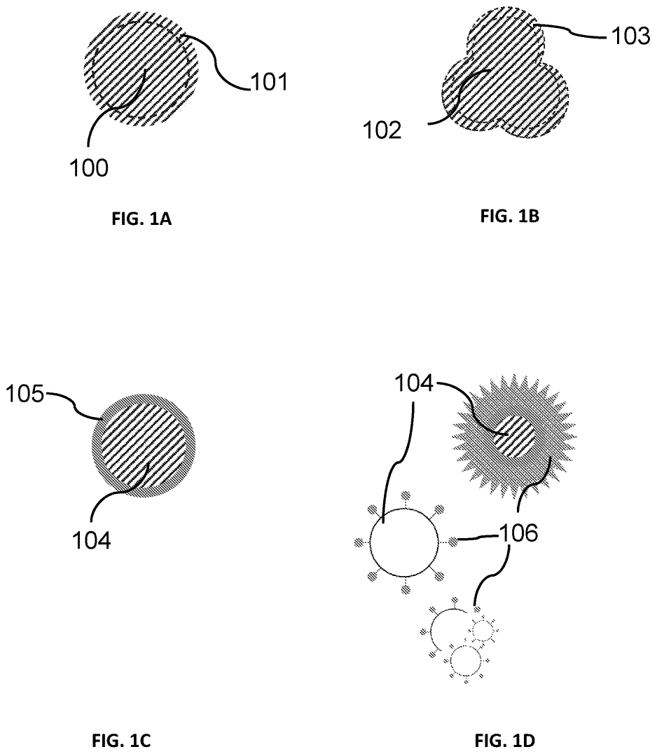

A membrane may be any outer shell and/or surface of a nano or micro particle that interfaces with a media (e.g., a fluid media, described elsewhere herein). In some cases, a capacitance of the membrane may be a combination of the capacitance across the surface and through the surface of the particle towards a core of the particle. FIGS. 1A-1D show the one or more types or characterizations of particles that may be membrane-bound particles, as described elsewhere herein. The particles can be homogenous (FIGS. 1A-1B) or heterogenous (FIGS. 1C-1D). In some cases, the core 100 and membrane and/or shell (101, 103) of homogenous particles may comprise the same material. The core 100 can be solid, gel or liquid, non-uniform or comprised of clustered particles 102, while the membrane (101, 103) may be the outer shell or surface of the particle. In some cases, the core 104 and membrane (105, 106) of heterogeneous particles may comprise different materials. The core 104 can be a solid, gel, liquid, and/or gas and may contain one or more materials and layers. The membrane of the heterogenous particles (105, 106) may comprise the outer shell or surface of the particle and can be comprised of biopolymers (such as lipids, proteins, and/or nucleic acids) or synthetic material, comprised of synthetic or biological polymers attached to the surface of the particle, or any combination thereof. For both homogeneous and heterogeneous particles, the particles can be standalone free or clustered and/or clumped particles. In some instances, the particles can be synthetic, synthetic biological, naturally occurring biological in origin, or any combination thereof.

In some cases, the homogenous particles and/or the heterogenous particles may comprise naturally occurring bioparticles, engineered particles, or a combination thereof. In some cases, homogenous particles may comprise particles enwrapped by a surface membrane shell made of the same material as the core, as described elsewhere herein. In some instances, heterogenous particles may comprise particles enwrapped by polymer members, particles enwrapped by lipid membranes, or a combination thereof. In some cases, naturally occurring bioparticles may comprise particles produced over a period of time (e.g., a life cycle) by a living organism(s). In some cases, engineered particles may comprise biosynthetic and/or synthetic particles. In some instances, biosynthetic particles may comprise synthesized copies of biological particles, synthetic hybrids, and/or synthetized particles that use biological processes as one or more manufacturing steps to generate the particles. In some instances, synthetic particles may comprise synthesized particles made from inorganic materials.

Naturally occurring homogenous bioparticles may comprise small non-vesicular bodies (e.g., exomeres, supermeres, or a combination thereof), individual proteins (e.g., nucleic acids such as DNA fragments), or a combination thereof. Biosynthetic homogenous particles may comprise solid micro and/or nanospheres made from organic polymers, a combination of solid microsphere and/or nanospheres with inorganic material, microbubbles, nanobubbles, or any combination thereof. Synthetic homogenous particles may comprise solid micro and/or nanosphere particles made from inorganic materials e.g., metal, metal oxides, and/or silica, microbubbles, nanobubbles, or any combination thereof.

Naturally occurring heterogenous particles enwrapped by polymer membranes may comprise particles enwrapped by a protein corona, e.g., protein complexes, vesicles, nucleic acids, nucleosomes, or any combination thereof. Biosynthetic particles enwrapped by polymer membranes may comprise core-shell particles with a shell comprised of organic polymers (e.g., insulin-containing microspheres), solid particles functionalized with biopolymer (e.g., gold nanoparticles functionalized with antibodies, proteins, DNA, functionalized magnetic beads, or any combination thereof), colloidal nanoparticles, dendrimers, or any combination thereof. Synthetic heterogenous particles enwrapped by polymer membranes may comprise inorganic polymer shell membranes encasing solid inorganic core (e.g., magnetic or non-magnetic metals), nanospheres, polymer micelles, inorganic dendrimers, or any combination thereof. Naturally occurring heterogenous bioparticles enwrapped by lipid membranes may comprise cells, organelles (e.g., mitochondria), extracellular vesicles (e.g., extracellular vesicles encapsulating proteins, nucleic acid molecules, exosomes, macrovesicles, apoptotic bodies), lipid vesicles (e.g., natural liposomes), lipoproteins, or any combination thereof. In some cases, biosynthetic heterogenous particles enwrapped by a lipid membrane may comprise synthetic nanoparticles and/or nanogels coated with membranes derived from cell populations (e.g., erythrocytes, macrophages, etc., or any combination thereof), engineered lipid nanocapsules and particles (e.g., liposomes, polymersomes, micellar lipid nanoparticles), or any combination thereof. In some cases, the naturally occurring heterogenous bioparticles enwrapped by lipid membranes may be functionalized to release encapsulated drugs (e.g., insulin), may improve targeting of a drug and/or therapeutic (e.g., through the use of surface proteins), may be used for biosensing purposes (e.g., dyes), or any combination thereof.

At frequencies less than about 1 MHz of an emitted electric field, a membrane of one or more particles with a diameter less than 1.8 μm, described elsewhere herein, may act as an insulating sphere while in the electric field where the interior of the particle is subjected to negligible effects of the electric field. Accordingly, the permittivity of a particle at frequencies less than about 100 kHz can be understood as proportional to the capacitance of the particle's membrane and inversely proportional to the radius of the particle (Equation 2).

$${ε}_{pr} = \frac{{C}_{mem}}{2 {πε}_{o} {r}_{p}} \qquad ( Equation 2 )$$

Cₘₑₘ is membrane capacitance of the particle
ε₀=permittivity of free space (8.85×10⁻¹² F/m), and
rₚ=radius of the particle

For particles greater than 1.8 μm in diameter, described elsewhere herein, the disclosure may describe methods of modifying a membrane permittivity by membrane permittivity modifiers (MPM) to alter and/or manipulate the membrane permittivity (e.g., capacitance) of the one or more particles facilitating isolation, elution, sorting, capturing, etc. of the one or more particles.

The methods and systems described elsewhere herein may isolate particles with diameters of up to 1.8 μm in solutions with high ionic strength (at least about 10 millimolar (mM)) as well as with mid ionic strength (e.g., 100 micromolar (μM) to 10 mM) and low ionic strength (<100 μM) by first identifying a frequency and permittivity that affect Clausius-Mossotti (CM) factor for targeted particles and then manipulating particles permittivity of targeted particles by generating spatially and/or temporally modulated alternating current electric fields at frequencies of up to 1 MHz, about 100 Hz to about 1 MHz, about 1 MHz to 20 MHz, or any combination thereof. In some cases, the methods, systems, and/or devices described elsewhere herein may isolate particles in solutions irrespective of conductivity of the solution. Various examples and scenarios of a calculated dielectric force with typical values of particle and media conductivity and/or permittivity are shown in Table 2. Also shown in Table 2 is the unexpected result or anomaly of the methods, devices, and/or systems described herein in generating a positive dielectric force to isolated particles by altering permittivity where the dielectric force equation would suggest otherwise.

TABLE 2
Dielectric Force Equation Example Scenarios for Media
and Particle Conductivity and/or Permittivity

| | Frequency of | | | Dielectric Force | |
|---|---|---|---|---|---|
| Conductivity of | applied | Δ Conductivity | Δ Permittivity | Per | |
| the media | electric field | σₚ − σₘ | (εₚᵣ − εₘᵣ)εₒ | Equation | Observed |
| Scenario 1 | Low | σₚ = 10⁻² S/m | εₚᵣ = ?? | POS | POS |
| Isolation of | <10⁵ Hz | σₘ = 10⁻⁴ S/m | (Incorrectly thought to be | | |
| exosomes in | | | 2.55-60) | | |
| low | | | εₘᵣ = 80 | | |
| conductivity | High | σₚ = 10⁻¹ S/m | εₚᵣ = 2.55 to 60 | NEG | NEG |
| buffer | >10⁷ Hz | σₘ = 10⁻³ S/m | εₘᵣ = 68 | | |
| Scenario 2 | Low | σₚ = 10⁻² S/m | εₚᵣ = ?? | NEG | ANOMOLY: |
| Isolation of | <10⁵ Hz | σₘ = 1 S/m | (Incorrectly thought to be | | Positive for |
| exosomes in | | | 2.55-60) | | particles < μm |
| high | | | εₘᵣ = 5240 | | diameter, |
| conductivity | | | | | Strongly positive |
| solution (blood | | | | | for particles >1.8 |
| or plasma | | | | | μm diameter |
| | High | σₚ = 10⁻¹ S/m | εₚᵣ = 2.55 to 60 | NEG | NEG |
| | >10⁷ Hz | σₘ = 10 S/m | εₘᵣ = 80 | | |

The systems of the disclosure described herein, configured to implement the methods of the disclosure may comprise combined electro-fluidic systems and/or devices comprising one or more channels, electrodes, inlets, outlets, sensors, or any combination thereof. In some instances, the systems may comprise a microfluidic device comprising one or more electrodes configured to emit one or more frequencies, frequency ranges (i.e., frequency temporal sweeps where a frequency is modified from a first frequency at a first time point to a second frequency at a second time point where the second time point follows the first time point) configured to isolate particles in spatially non-overlapping positions and/or at temporally discrete points in time, described elsewhere herein. In some cases, the microfluidic device may comprise a flow cell. In some cases, the microfluidic device may comprise a microplate or multiwell plate.

Membrane-bound particles isolated by the methods, devices, and/or systems, described elsewhere herein, may comprise particles, including cell-derived membrane bound particles e.g., exomeres, small exosomes, large exosomes, microvesicles, ectosomes, migrasomes, synthetic particles, or any combination thereof. In some cases, cell-derived membrane bound particles may comprise necroptotic, apoptotic, and/or pyroptotic bodies, and other membrane bound bodies produced as a result of cell death. Synthetic nanovesicles and coated particles may be generated by supramolecular chemistry or other manufacturing methods. The particles may comprise synthetic nanoparticles e.g., chemically synthetic liposomes, gold, platinum, silver, titanium, ceramics, metal oxides, glass particles (silica beads, silicon dioxide, silicon nitride, borosilicate glass, or any combination thereof), rubber particles (natural and/or silicone rubber, etc.), graphene oxide, polystyrene, polypropylene, conjugated polymers (PVDF polymers and/or co-polymers, PARQ co-polymers (e.g., HO-PAQR and RO-PAQR, etc.), cuPc, FePc, PTTEMA/PS, Polythiourea blends, etc.), polymer and ceramic composites, polymer and metal composites, polymers with hyperbranched structures (hyper branched polyanilines etc.), or any combination thereof. The synthetic nanoparticles may be applied to a surface of the cell-derived membranes to improve the isolation of the particles. Examples, sizes and size ranges of the cell-derived membrane bound particles, synthetic and biosynthetic nanoparticles that may be isolated by the methods, devices, and/or systems described herein are described in Table 1A and Table 1B.

TABLE 1A
Examples of key classes of membrane bound particles by membrane type

| | | Examples of Membrane-bound particles by biogenesis | | |
|---|---|---|---|---|
| | | | Engineered Particles | |
| | | | Biosynthetic | |
| | | | Synthesized copies of | |
| | | | biological particles, | |
| Key classes | | Naturally occurring | synthetic hybrids, and or | Synthetic particles |
| of membrane | | bioparticles | synthesized particles that | Synthesized |
| bound | Key types of | Produced over the course | use biological processes | particles, made |
| particles | membrane | of lifecycle by living | as one or more | from inorganic |
| (MBP) | surface shells | organisms | manufacturing steps | materials |
| Homogenous | Particles | Small non-vesicular | Solid | Solid |
| particles | enwrapped | bodies (exomeres, | micro/nanospheres | micro/nanospheres |
| | by surface | supermeres) | made out of organic | made out of |
| | membrane | Individual proteins | polymers or their | inorganic materials, |
| | shell made of | Nucleic acid molecules | combination with | such as metal, metal |
| | the same | (e.g., DNA, RNA, or | inorganic materials | oxides, and silica |
| | material as | fragments thereof) | Microbubbles and | Microbubbles and |
| | the core | | nanobubbles | nanobubbles |
| Heterogenous | Particles | Particles enwrapped by | Core-shell particles | Inorganic polymer |
| particles | enwrapped | protein corona (protein | with shells made of | shell membranes |
| | by polymer | complexes, vesicles, | organic polymers | that encase solid |
| | membranes | nucleic acids and other) | (insulin-containing | inorganic core |
| | | Nucleosomes | microspheres) | such as metals (e.g., |
| | | | Solid particles | magnetic or non- |
| | | | functionalized with | magnetic metals) |
| | | | biopolymers (e.g., gold | Nanospheres |
| | | | nanoparticles | Polymer micelles, |
| | | | functionalized with | inorganic |
| | | | antibodies, proteins, | dendrimers |
| | | | DNA, functionalized | |
| | | | magnetic beads) | |
| | | | Colloidal nanoparticles | |
| | | | Dendrimers | |
| | Particles | Cells | Synthetic nanoparticles | n/a |
| | enwrapped | Organelles (incl. | and nanogels coated in | |
| | by lipid | mitochondria) | membranes derived from | |
| | membranes | Extracellular vesicles | specific cell populations | |
| | | encapsulating proteins, | (erythrocytes, | |
| | | nucleic acids, and other | macrophage, etc) | |
| | | molecules (exosomes, | Engineered lipid | |
| | | | nanocapsules and | |
| | | | particles, such as | |
| | | | liposomes, polymersomes | |
| | | macrovesicles, apoptotic | and micellar lipid | |
| | | bodies, and others) | nanoparticles | |
| | | Lipid vesicles (incl. natural | Membrane could be | |
| | | liposomes) | functionalized to release | |
| | | Lipoproteins | encapsulated drugs (e.g. | |
| | | | insulin), improve | |
| | | | targeting (surface | |
| | | | proteins) or for | |
| | | | biosensing purposes | |
| | | | (dyes) | |

TABLE 1 B
Examples of membrane bound particles by size

| Category | Particle Size (diameter) | | Particle Type | Particle subtype |
|---|---|---|---|---|
| Naturally | <50 | nm | EVs, biopolymers, | Exomeres, supermeres, DNA, |
| occurring | | | organelles | RNA, proteins |
| particles | <100 | nm | | Lipoproteins |
| | 60-80 | nm | | Small exosomes, aggregated |
| | | | | proteins, nucleosomes |
| | 90-120 | nm | | Large exosomes |
| | 40-200 | nm | | ARRDC1 mediated |
| | | | | macrovesicles (ARMMs) |
| | 100 nm-1000 nm | | | Microvesicles, ectosomes, |
| | | | | organelles, filopodium derived |
| | | | | vesicles |
| | 500 nm-3000 nm | | | Migrasomes |
| | 500-1000+ | nm | | Oncosomes, exophers |
| | >500 | nm | Cell death markers | |
| | 500-2000 | nm | | Necroptotic, apoptotic, and |
| | (>1000 | nm) | | pyroptotic bodies and other |
| | | | | membrane bound bodies produced |
| | | | | as a result of cell death |
| | 20-500 nm, 500 nm- | | Cells | Virus, Bacteria, RBC, WBC, |
| | 5 μm, >4 μm, >10 | | | CTC/CEC, all other cell types, |
| | μm, .16 μm | | | respectively etc. |
| Synthetic | 1 nm-500 nm | | Drug delivery | Polymeric, inorganic and lipid- |
| and | | | nanoparticles | based drug carries, such as |
| biosynthetic | | | | liposomes, micelles, dendrimers, |
| nanoparticles | | | | polymersomes, nanospheres, etc. |

| 1 nm-500 nm | Metal nanoparticles | Gold, platinum, silver, titanium, |
|---|---|---|
| | (coated and | etc. |
| | uncoated) | |
| 1 nm-50 μm | Non-metal | Ceramics, metal oxides, graphene |
| | nanoparticles | oxide, silica beads, silicon |
| | | dioxide, glass, rubber (both |
| | | natural and/or silicone) etc. |
| 1 nm-50 μm | Polymer | Polystyrene, polypropylene, |

| | |
|---|---|
| nanoparticles | conjugated polymers [PVDF |
| | polymers or copolymers-P(VDF- |
| | CTFE), (P(TFE-HFP)), (PVDF-g- |
| | HEMA)] PARQ copolymers (e.g., |
| | HO-PAQR and RO-PAQR, etc.), |
| | cuPc, FePc, PTTEMA/PS, |
| | Polythiourea blends, polythiourea |
| | dielectrics with aromatic ring |
| | structures, polymer and ceramic |
| | particle composites, polymer and |
| | metal composites, naturally |
| | occurring and organic protein |
| | coronas, synthesized nucleic acids |
| | and other biopolymers, |
| | corpolymers with hyperbranched |
| | structures (hyper branched |
| | polyanilines) or any combination |
| | thereof. |

In some cases, the one or more cell-derived membrane bound particles may comprise a diameter of about 50 nm to about 100,000 nm. In some cases, the one or more cell-derived membrane bound particles may comprise a diameter of about 50 nm to about 80 nm, about 50 nm to about 100 nm, about 50 nm to about 200 nm, about 50 nm to about 500 nm, about 50 nm to about 1,000 nm, about 50 nm to about 5,000 nm, about 50 nm to about 8,000 nm, about 50 nm to about 16,000 nm, about 50 nm to about 30,000 nm, about 50 nm to about 50,000 nm, about 50 nm to about 100,000 nm, about 80 nm to about 100 nm, about 80 nm to about 200 nm, about 80 nm to about 500 nm, about 80 nm to about 1,000 nm, about 80 nm to about 5,000 nm, about 80 nm to about 8,000 nm, about 80 nm to about 16,000 nm, about 80 nm to about 30,000 nm, about 80 nm to about 50,000 nm, about 80 nm to about 100,000 nm, about 100 nm to about 200 nm, about 100 nm to about 500 nm, about 100 nm to about 1,000 nm, about 100 nm to about 5,000 nm, about 100 nm to about 8,000 nm, about 100 nm to about 16,000 nm, about 100 nm to about 30,000 nm, about 100 nm to about 50,000 nm, about 100 nm to about 100,000 nm, about 200 nm to about 500 nm, about 200 nm to about 1,000 nm, about 200 nm to about 5,000 nm, about 200 nm to about 8,000 nm, about 200 nm to about 16,000 nm, about 200 nm to about 30,000 nm, about 200 nm to about 50,000 nm, about 200 nm to about 100,000 nm, about 500 nm to about 1,000 nm, about 500 nm to about 5,000 nm, about 500 nm to about 8,000 nm, about 500 nm to about 16,000 nm, about 500 nm to about 30,000 nm, about 500 nm to about 50,000 nm, about 500 nm to about 100,000 nm, about 1,000 nm to about 5,000 nm, about 1,000 nm to about 8,000 nm, about 1,000 nm to about 16,000 nm, about 1,000 nm to about 30,000 nm, about 1,000 nm to about 50,000 nm, about 1,000 nm to about 100,000 nm, about 5,000 nm to about 8,000 nm, about 5,000 nm to about 16,000 nm, about 5,000 nm to about 30,000 nm, about 5,000 nm to about 50,000 nm, about 5,000 nm to about 100,000 nm, about 8,000 nm to about 16,000 nm, about 8,000 nm to about 30,000 nm, about 8,000 nm to about 50,000 nm, about 8,000 nm to about 100,000 nm, about 16,000 nm to about 30,000 nm, about 16,000 nm to about 50,000 nm, about 16,000 nm to about 100,000 nm, about 30,000 nm to about 50,000 nm, about 30,000 nm to about 100,000 nm, or about 50,000 nm to about 100,000 nm. In some cases, the one or more cell-derived membrane bound particles may comprise a diameter of about 50 nm, about 80 nm, about 100 nm, about 200 nm, about 500 nm, about 1,000 nm, about 5,000 nm, about 8,000 nm, about 16,000 nm, about 30,000 nm, about 50,000 nm, or about 100,000 nm. In some cases, the one or more cell-derived membrane bound particles may comprise a diameter of at least about 50 nm, about 80 nm, about 100 nm, about 200 nm, about 500 nm, about 1,000 nm, about 5,000 nm, about 8,000 nm, about 16,000 nm, about 30,000 nm, or about 50,000 nm. In some cases, the one or more cell-derived membrane bound particles may comprise a diameter of at most about 80 nm, about 100 nm, about 200 nm, about 500 nm, about 1,000 nm, about 5,000 nm, about 8,000 nm, about 16,000 nm, about 30,000 nm, about 50,000 nm, or about 100,000 nm.

In some cases, the one or more synthetic particles may comprise a diameter of about 1 nm to about 50,000 nm. In some cases, the one or more synthetic particles may comprise a diameter of about 1 nm to about 50 nm, about 1 nm to about 80 nm, about 1 nm to about 100 nm, about 1 nm to about 500 nm, about 1 nm to about 1,000 nm, about 1 nm to about 5,000 nm, about 1 nm to about 10,000 nm, about 1 nm to about 20,000 nm, about 1 nm to about 25,000 nm, about 1 nm to about 50,000 nm, about 50 nm to about 80 nm, about 50 nm to about 100 nm, about 50 nm to about 500 nm, about 50 nm to about 1,000 nm, about 50 nm to about 5,000 nm, about 50 nm to about 10,000 nm, about 50 nm to about 20,000 nm, about 50 nm to about 25,000 nm, about 50 nm to about 50,000 nm, about 80 nm to about 100 nm, about 80 nm to about 500 nm, about 80 nm to about 1,000 nm, about 80 nm to about 5,000 nm, about 80 nm to about 10,000 nm, about 80 nm to about 20,000 nm, about 80 nm to about 25,000 nm, about 80 nm to about 50,000 nm, about 100 nm to about 500 nm, about 100 nm to about 1,000 nm, about 100 nm to about 5,000 nm, about 100 nm to about 10,000 nm, about 100 nm to about 20,000 nm, about 100 nm to about 25,000 nm, about 100 nm to about 50,000 nm, about 500 nm to about 1,000 nm, about 500 nm to about 5,000 nm, about 500 nm to about 10,000 nm, about 500 nm to about 20,000 nm, about 500 nm to about 25,000 nm, about 500 nm to about 50,000 nm, about 1,000 nm to about 5,000 nm, about 1,000 nm to about 10,000 nm, about 1,000 nm to about 20,000 nm, about 1,000 nm to about 25,000 nm, about 1,000 nm to about 50,000 nm, about 5,000 nm to about 10,000 nm, about 5,000 nm to about 20,000 nm, about 5,000 nm to about 25,000 nm, about 5,000 nm to about 50,000 nm, about 10,000 nm to about 20,000 nm, about 10,000 nm to about 25,000 nm, about 10,000 nm to about 50,000 nm, about 20,000 nm to about 25,000 nm, about 20,000 nm to about 50,000 nm, or about 25,000 nm to about 50,000 nm. In some cases, the one or more synthetic particles may comprise a diameter of about 1 nm, about 50 nm, about 80 nm, about 100 nm, about 500 nm, about 1,000 nm, about 5,000 nm, about 10,000 nm, about 20,000 nm, about 25,000 nm, or about 50,000 nm. In some cases, the one or more synthetic particles may comprise a diameter of at least about 1 nm, about 50 nm, about 80 nm, about 100 nm, about 500 nm, about 1,000 nm, about 5,000 nm, about 10,000 nm, about 20,000 nm, or about 25,000 nm. In some cases, the one or more synthetic particles may comprise a diameter of at most about 50 nm, about 80 nm, about 100 nm, about 500 nm, about 1,000 nm, about 5,000 nm, about 10,000 nm, about 20,000 nm, about 25,000 nm, or about 50,000 nm.

Isolating one or more cell-derived, and/or synthetic particles may be a necessary component for applications e.g., drug discovery, fluid-based disease diagnostics, disease and/or physiologic state biomarker discovery, or any combination thereof applications. The isolated one or more cell-derived, and/or synthetic particles may be utilized in downstream analysis. Downstream analysis may comprise, transmission electron microscopy (TEM), atomic force microscopy (AFM), nanoparticle tracking analysis (NTA), single extra cellular analysis (SEA), tunable resistive pulse sensing (TRPS), flow cytometry, western blot, enzyme-linked immunosorbent assay (ELISA), mass spectrometry (MS), liquid chromatography-tandem mass spectrometry (LCMS/MS), nucleic acid extraction, polymerase chain reaction (PCR), nucleic acid sequencing (e.g., next generation sequencing, sequencing-by-synthesis, nanopore sequencing, etc.), additional fractionation steps, or any combination thereof.

The isolated particle or plurality of particles (e.g., extracellular vesicles, proteins and nucleic acids) may be used in diagnosing, prognosing, and/or recommending adjustment to treatments for one or more disease areas. Naturally occurring particles isolated by the systems, devices, and/or methods described elsewhere herein, are secreted by nearly all types of cells, and commonly found in bodily fluid (e.g., urine, blood, ascites, cerebrospinal fluid, etc.). These particles may be secreted by one or more cell types, e.g., dendritic cells (DCs), B cells, T cells, mast cells, epithelial cells, tumor cells, viruses, bacteria, or any combination thereof cells. Membranes of membrane-bound particles may encapsulate other particles that contain molecular analytes e.g., metabolites, exosomal DNA, mitochondrial DNA, RNAs, intracellular and membrane-spanning proteins, or any combination thereof which are analyzed by further downstream processes, described elsewhere herein. The one or more disease areas may comprise oncology, neurodegenerative diseases, aging, regenerative health and/or healing, vaccines, autoimmune diseases and/or immunomodulation, infectious disease, endocrine, or any combination thereof.

The one or more diseases or conditions of the one or more disease areas may comprise cancer, Alzheimer's, Parkinson, amyotrophic lateral sclerosis (ALS), stroke, psoriasis, colitis, irritable bowel syndrome (IBS), sepsis, cardiovascular diseases, multiple sclerosis, fissures, acute myocardial infarction, spinal cord injuries, wound healing, COVID-19, asthma, diabetes, obesity, or any combination thereof. In some cases, cancer may comprise lung cancer, pancreatic cancer, blood cancers, liver cancer, prostate cancer, brain cancer, colon cancer, skin cancer, or any combination thereof cancers.

The methods, systems, and/or devices described elsewhere herein may isolate, capture, separate and/or elute membrane-bound-particles from biological fluids (e.g., blood, cerebrospinal fluid, urine, etc., described elsewhere herein) and synthetic and biosynthetic buffers for one or more biomedical applications in the one or more of the disease areas. The one or more biomedical applications of the information derived from isolated membrane-bound particles may comprise deriving genomic, proteomic, transcriptomic, epigenomic, epitranscriptomic, fragmentomic, lipidomic and other multi-omic data from the isolated membrane-bound-particles and using that data in biomarker applications, basic research, biomedical research, computational biology, drug discovery, and therapeutic development.

Drug discovery may involve the analysis of the isolated membrane-bound particles, as described elsewhere herein, and analysis of the content of the EVs with a goal to understand drug's mechanism of action, targetable pathways and/or new drug targets determined by, e.g., analyzing the contents of the particles prior to and after administering a drug candidate, a pharmaceutical substance, or another intervention. Drug discovery may involve using the results of the analysis of the isolated membrane-bound particles to construct high resolution computational models of cells, cellular and subcellular interactions for the purposes of computational disease modeling, digital compounds testing, drug candidate selection, prediction of adverse events and other computational approaches.

Diagnostic applications and the use of isolated membrane-bound particles as biomarkers may include uses of particle's content thereof for early-stage disease diagnosis, disease prognosis, predicting onset of disease, monitoring disease, detecting and/or predicting disease recurrence, or any combination thereof. For example, the measurement and detection level of exosomal content (e.g., exosomal DNA, RNA, and proteins) of isolated EVs from human, non-human animals, bacteria, or plants may be used as a biomarker for early-stage disease diagnosis, disease prognosis, predicting onset of disease, monitoring disease, detecting and/or predicting disease recurrence, or any combination thereof. Diagnostic applications can also include isolation of membrane-bound particles (as described elsewhere herein) in wastewater to follow diseases at the population level screening.

Therapeutic development may use isolated synthetic and biosynthetic membrane-bound particles to deliver therapeutic agents, using particle's membrane shell structure as a containing, transporting, targeting, and sensing mechanism. Therapeutic development may comprise the use methods, systems, and/or devices described elsewhere herein may to isolate, capture, separate and/or elute synthetic and biosynthetic membrane-bound-particles from biological, synthetic and biosynthetic buffers during one or more manufacturing steps for drug nanocarriers. Therapeutic development may comprise the use of cell line derived vesicles for therapeutic delivery, exosome-mimetic nanovesicles (EMNVs) for therapeutic delivery, and therapeutic delivery particles with modified outer shell membranes to improve cellular and intracellular targeting and/or sensing (release of a therapeutic agent in response to pH, etc). In some cases, the endogenous content within cell-derived vesicles that may be used for therapeutic delivery could interfere with the mechanism of action of the delivered therapeutic. The methods, systems, and/or devices described elsewhere herein, may be used to isolate the synthetic and biosynthetic nanocarriers, as well as naturally occurring membrane-bound particles to analyze the contents that would assist in determining any negative and/or positive interactions between phenotype and the therapeutic agent when the synthetic and biosynthetic membrane-bound particles would be used as a therapeutic delivery agents. In some instances, the methods, systems, and/or devices described elsewhere herein may provide measurement of in-vivo pharmacokinetic (PK), pharmacodynamic (PD), or any combination thereof measurements of therapeutic characteristics of drug carrying particles (e.g., cell line derived exosomes, EMNVS, and/or drug delivery particles with modified membranes for improved therapeutic targeting) or other therapeutic agents and interventions. In some cases, synthetic and biosynthetic membrane-bound particles may be used as therapeutics in dermatology and cutaneous medical aesthetics. In some cases, synthetic and biosynthetic membrane-bound particles may be used in medical imaging as contrast agents. In some instances, membrane-bound nanocarriers may be used as vaccine delivery vectors.

Isolated membrane-bound particles and/or the encapsulated contents thereof may be used as biomarkers during drug development. The biomarker uses during drug development may comprise mechanism of action assay, diagnostic, monitoring, predictive, prognostic, pharmacodynamic and/or response, safety, risk management, or any combination thereof uses. The isolated membrane-bound particles and/or encapsulated content thereof may provide a diagnostic capability of whether one or more subjects have one or more diseases or a phenotypic and/or anatomical classification and whether they should receive a treatment. The isolated membrane-bound particles and/or encapsulated content thereof may be used to monitor, for example, a change in a degree and/or development of a disease of one or more subjects, toxicity, or safety of a treatment for a disease of one or more subjects, evidence of exposure of a subject to a disease or a treatment to a disease, or any combination thereof. In some cases, the isolated membrane-bound particles and/or encapsulated content thereof may be used to monitor potential disease recurrence of one or more subjects. In some instances, the isolated membrane-bound particles and/or encapsulated content thereof may be used when predicting a response to a treatment of a disease of one or more subjects. In some instances, the isolated membrane-bound particles and/or encapsulated contents thereof may be used in prognostic methods, for example, to stratify one or more subjects and to develop inclusion and/or exclusion criterion when preparing clinical trial patient cohorts. In some instances, the isolated membrane-bound particles and/or encapsulated contents thereof may be used to determine efficacy of a biomarker/surrogate end point and/or show biological response related to an intervention and/or exposure for one or more subject. In some cases, the isolated membrane-bound particles and/or the encapsulated contents thereof may be used to indicate the presence or extent of toxicity related to a therapeutic, intervention, and/or exposure to disease of one or more subjects. In some cases, the isolated membrane-bound particles and/or the encapsulated contents thereof may be used to indicate the potential for developing a disease or a sensitivity to an exposure to one or more diseases for one or more subjects. In some cases, isolated membrane-bound particles may be used as biomarkers of early cancer detection. In some instances, isolated membrane-bound particles may be used as substitutes for cerebral spine fluid biomarkers.

### Spatial and Temporal Particle Isolation

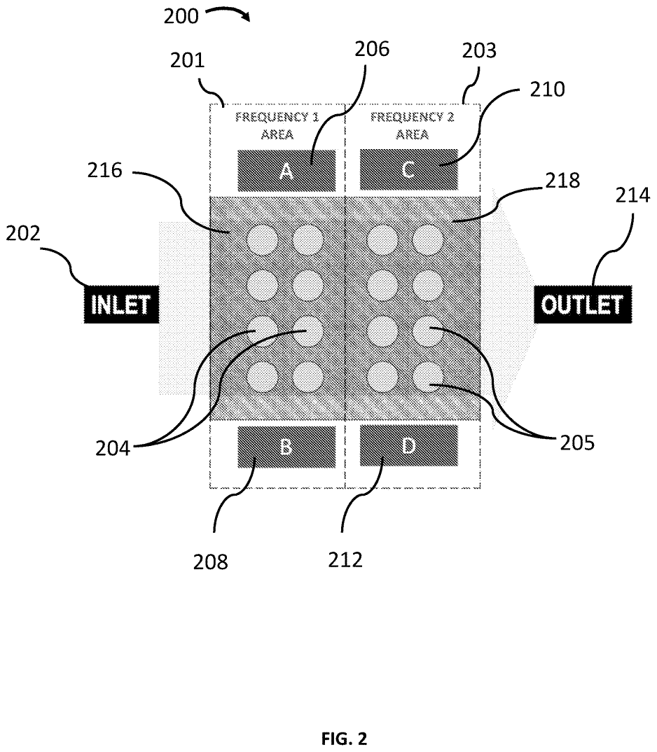

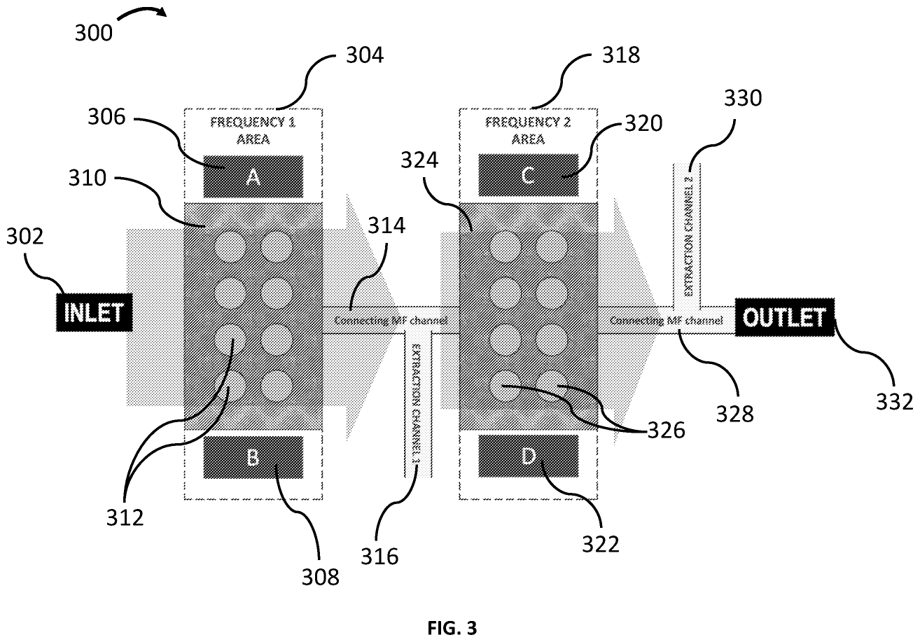

In some embodiments, the device and/or systems (200, 300) described herein may implement methods to isolate particles across one or more spatially non-overlapping regions and/or temporally, as shown in FIG. 2 and FIG. 3. Turning, to device and/or system (200 and 300) as shown in FIG. 2 and FIG. 3, in some cases, a first particle or a first plurality of particles (204, 312) may be isolated at a first spatial position (216, 310), and a second particle or a second plurality of particles (205, 326) may be isolated at a second spatial position (218, 324), where the first spatial position and the second spatial position do not spatially overlap with one another. In some cases, the first spatial position may be within a first isolation area (201, 304) and the second spatial position may be within a second isolation area (318, 203). In some cases, the first spatial position (216, 310) may comprise a first spatial area and the second spatial position (218, 324) may comprise a second spatial area where the first and second particle or first and second plurality of particles are isolated. In some cases, a first spatial position (216, 310) and second spatial position (218, 324) may be generated between at least two electrodes of the first spatial position (206 and 208; 306 and 308) and of the second position (210 and 212; 320 and 322). In some cases, the at least two electrodes may comprise a signal electrode (206, 210, 306, 320) and a sink electrode (208, 212, 308, 322). In some instances, the signal electrode (206, 210, 306, 320) may be configured to emit one or more alternating current (AC) electrical signals with one or more frequencies, frequency ranges or any combination thereof signals. The emitted AC signal from the signal electrode (206, 210, 306, 320) may travel in the direction of the sink electrodes (208, 212, 308, 322) thereby establishing an AC electric field in the first spatial position (216, 310) and second spatial position (218, 324) configured to attract and/or isolate the first particle or first plurality of particles (204, 312) and/or the second particle or second plurality of particles (205, 326). One or more particles may be isolated in regions of electrodes providing a corresponding one or more frequencies or frequency ranges configured to attract the size of the particles.

The signal and sink electrodes may be adjacent to a surface and/or embedded into a chip. The chip may comprise a substrate, where the substrate may comprise one or more electrical paths electrically coupled to the sink and/or signal electrodes and other computer systems, described elsewhere herein. The electrical paths may transmit one or more frequencies and/or one or more frequency ranges to the signal and sink electrodes to isolate one or more particles and/or one or more plurality of particles. In some cases, the chip may be configured to conducted on-chip analysis of the isolated one or more particles and/or one or more plurality of particles once isolated. In some cases, the substrate may be made of a carbon-based material (e.g., plastics), semi-conductor material (e.g., silicon or gallium arsenide), an insulating material (e.g., glass or indium tin oxide), or any combination thereof. In some instances, the substrate may comprise a printed circuit board, where the one or more electrical paths comprise one or more electrical traces of the printed circuit board. In some cases, the substrate may comprise one or more conductive regions and one or more non-conductive regions. In some instances, the substrate may be flexible (e.g., plastic) or may be rigid (e.g., glass).

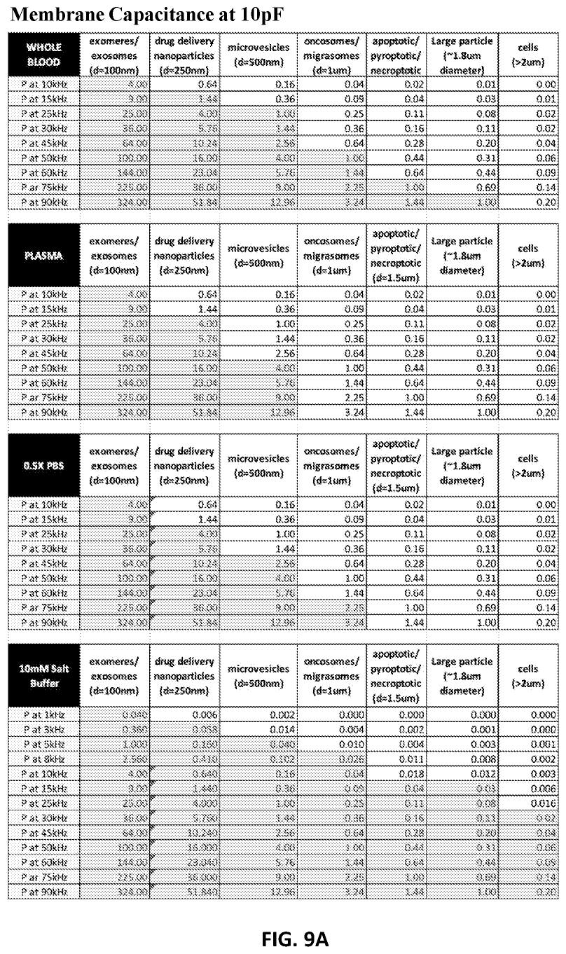

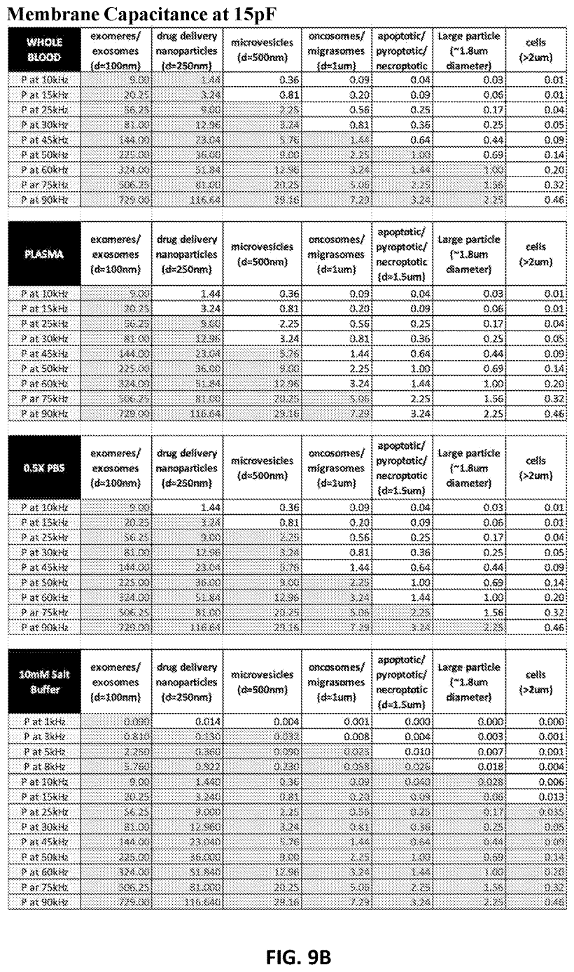

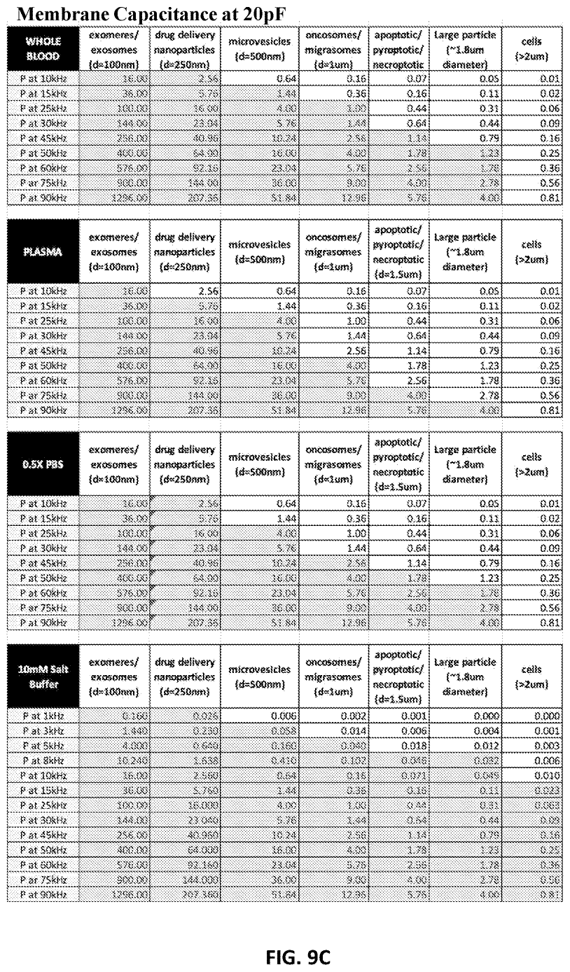

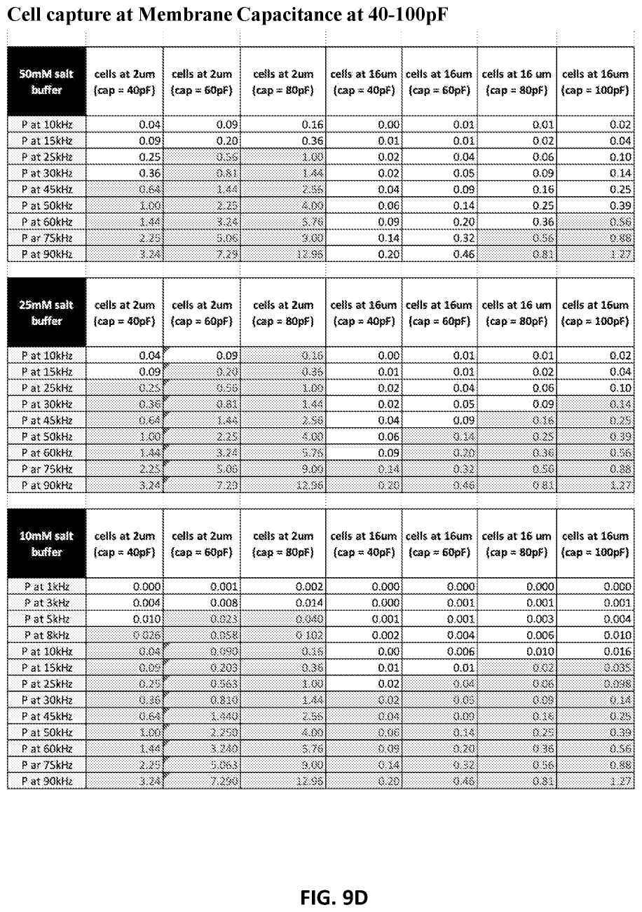

Example frequency values to isolate and/or attract one or more particles with varying membrane permittivity in example fluid media may be seen in FIGS. 9A-9D. The highlighted portion of the data shown in FIGS. 9A-9D indicates the frequency whereby the particles listed were isolated and/or attracted to the one or more electrodes, described elsewhere herein. The data of FIGS. 9A-9D may be used and a lookup table when determining one or more frequencies and/or one or more ranges of frequencies to isolate particles and/or for a basis to initially train one or more predictive and/or machine learning models, described elsewhere herein.

In some embodiments, the device and/or systems (200, 300) described herein may comprise one or more sensors configured to measure a parameter of a particle and/or a plurality of particles of a fluid sample. In some cases, the one or more sensors may comprise a sensor configured to measure capacitance or a size (e.g., diameter) of a particle or a plurality of particles. In some instances, the one or more sensors may comprise light-based sensors and/or a camera configured to collect one or more images and/or video of the particles to determine a particle size (e.g., diameter). The measured size may be used by algorithms and/or predictive models, described elsewhere herein, to determine a frequency or a range of frequencies to apply to one or more electrodes to isolate the particle or plurality of particles.

In some embodiments, a first particle or first plurality of particles and a second particle or second plurality of particles may both be isolated in a first spatial position or a second spatial position but at varying times (i.e., temporally). For example, the first particle or first plurality of particles may be isolated at the first spatial position (216, 310) at a first time, and the second particle or second plurality of particles may be isolated at the first spatial position (216, 310) at a second time, where the second time follows the first time. In some cases, the temporal isolation method may comprise: (a) providing a fluid composition comprising a first particle or first plurality of particles and a second particle or second plurality of particles to a system and/or device (200, 300); (b) applying a first frequency at a first region (216, 310) to isolate the first particle (204, 312); (c) and applying a second frequency at the first region (216, 310) to isolate a second particle. In some cases, the device and/or systems (200, 300) may comprise an inlet (202, 302) configured to receive the fluid composition and direct the fluid composition to the first region (216, 310). In some cases, the method may comprise providing a first eluting or washing solution step between step (b) and (c) to elute or extract the non-isolated and/or free floating second particle or second plurality of particles and/or contaminates prior to eluting and/or extracting the isolated first particle or first plurality of particles. In some instances, the method may further comprise removing the first frequency and/or frequency range and providing a second eluting or washing solution after step (b) to elute or extract the first particle or first plurality of particles. In some cases, the method may further comprise removing the second frequency and/or frequency range and providing a third eluting or washing solution after step (c) to elute and/or extract the second particle or second plurality of particles. In some cases, the first frequency may comprise a first frequency range and the second frequency may comprise a second frequency range, described elsewhere herein.

In some cases, both spatial and temporal isolation may be combined. In some instances, the device and/or systems (200, 300), described elsewhere herein, may temporally isolate particles at spatially non-overlapping regions. For example, the devices and/or systems described herein may temporally isolate a first set of particles with a first range of frequencies at a first region and temporally isolate a second set of particles with a second range of frequencies at a second region, where the first region and the second region do not overlap, and where the first range of frequencies and the second range of frequencies differ.

In some instances, the one or more frequencies and/or frequency ranges may comprise a frequency of about 0.05 kHz to about 2,000 kHz. In some instances, the one or more frequencies and/or frequency ranges may comprise a frequency of about 0.05 kHz to about 0.1 kHz, about 0.05 kHz to about 1 kHz, about 0.05 kHz to about 5 kHz, about 0.05 kHz to about 10 kHz, about 0.05 kHz to about 50 kHz, about 0.05 kHz to about 100 kHz, about 0.05 kHz to about 200 kHz, about 0.05 kHz to about 600 kHz, about 0.05 kHz to about 800 kHz, about 0.05 kHz to about 1,000 kHz, about 0.05 kHz to about 2,000 kHz, about 0.1 kHz to about 1 kHz, about 0.1 kHz to about 5 kHz, about 0.1 kHz to about 10 kHz, about 0.1 kHz to about 50 kHz, about 0.1 kHz to about 100 kHz, about 0.1 kHz to about 200 kHz, about 0.1 kHz to about 600 kHz, about 0.1 kHz to about 800 kHz, about 0.1 kHz to about 1,000 kHz, about 0.1 kHz to about 2,000 kHz, about 1 kHz to about 5 kHz, about 1 kHz to about 10 kHz, about 1 kHz to about 50 kHz, about 1 kHz to about 100 kHz, about 1 kHz to about 200 kHz, about 1 kHz to about 600 kHz, about 1 kHz to about 800 kHz, about 1 kHz to about 1,000 kHz, about 1 kHz to about 2,000 kHz, about 5 kHz to about 10 kHz, about 5 kHz to about 50 kHz, about 5 kHz to about 100 kHz, about 5 kHz to about 200 kHz, about 5 kHz to about 600 kHz, about 5 kHz to about 800 kHz, about 5 kHz to about 1,000 kHz, about 5 kHz to about 2,000 kHz, about 10 kHz to about 50 kHz, about 10 kHz to about 100 kHz, about 10 kHz to about 200 kHz, about 10 kHz to about 600 kHz, about 10 kHz to about 800 kHz, about 10 kHz to about 1,000 kHz, about 10 kHz to about 2,000 kHz, about 50 kHz to about 100 kHz, about 50 kHz to about 200 kHz, about 50 kHz to about 600 kHz, about 50 kHz to about 800 kHz, about 50 kHz to about 1,000 kHz, about 50 kHz to about 2,000 kHz, about 100 kHz to about 200 kHz, about 100 kHz to about 600 kHz, about 100 kHz to about 800 kHz, about 100 kHz to about 1,000 kHz, about 100 kHz to about 2,000 kHz, about 200 kHz to about 600 kHz, about 200 kHz to about 800 kHz, about 200 kHz to about 1,000 kHz, about 200 kHz to about 2,000 kHz, about 600 kHz to about 800 kHz, about 600 kHz to about 1,000 kHz, about 600 kHz to about 2,000 kHz, about 800 kHz to about 1,000 kHz, about 800 kHz to about 2,000 kHz, or about 1,000 kHz to about 2,000 kHz. In some instances, the one or more frequencies and/or frequency ranges may comprise a frequency of about 0.05 kHz, about 0.1 kHz, about 1 kHz, about 5 kHz, about 10 kHz, about 50 kHz, about 100 kHz, about 200 kHz, about 600 kHz, about 800 kHz, about 1,000 kHz, or about 2,000 kHz. In some instances, the one or more frequencies and/or frequency ranges may comprise a frequency of at least about 0.05 kHz, about 0.1 kHz, about 1 kHz, about 5 kHz, about 10 kHz, about 50 kHz, about 100 kHz, about 200 kHz, about 600 kHz, about 800 kHz, or about 1,000 kHz. In some instances, the one or more frequencies and/or frequency ranges may comprise a frequency of at most about 0.1 kHz, about 1 kHz, about 5 kHz, about 10 kHz, about 50 kHz, about 100 kHz, about 200 kHz, about 600 kHz, about 800 kHz, about 1,000 kHz, or about 2,000 kHz.

In some instances, the one or more frequencies for isolating and/or capturing one or more particles or one or more plurality of particles of up to about 500 nm diameter, may comprise a frequency of about 1 MHz to about 20 MHz. In some instances, the one or more frequencies for isolating and/or capturing one or more particles or one or more plurality of particles of up to about 500 nm diameter, may comprise a frequency of about 1 MHz to about 2 MHz, about 1 MHz to about 4 MHz, about 1 MHz to about 8 MHz, about 1 MHz to about 10 MHz, about 1 MHz to about 12 MHz, about 1 MHz to about 14 MHz, about 1 MHz to about 16 MHz, about 1 MHz to about 18 MHz, about 1 MHz to about 20 MHz, about 2 MHz to about 4 MHz, about 2 MHz to about 8 MHz, about 2 MHz to about 10 MHz, about 2 MHz to about 12 MHz, about 2 MHz to about 14 MHz, about 2 MHz to about 16 MHz, about 2 MHz to about 18 MHz, about 2 MHz to about 20 MHz, about 4 MHz to about 8 MHz, about 4 MHz to about 10 MHz, about 4 MHz to about 12 MHz, about 4 MHz to about 14 MHz, about 4 MHz to about 16 MHz, about 4 MHz to about 18 MHz, about 4 MHz to about 20 MHz, about 8 MHz to about 10 MHz, about 8 MHz to about 12 MHz, about 8 MHz to about 14 MHz, about 8 MHz to about 16 MHz, about 8 MHz to about 18 MHz, about 8 MHz to about 20 MHz, about 10 MHz to about 12 MHz, about 10 MHz to about 14 MHz, about 10 MHz to about 16 MHz, about 10 MHz to about 18 MHz, about 10 MHz to about 20 MHz, about 12 MHz to about 14 MHz, about 12 MHz to about 16 MHz, about 12 MHz to about 18 MHz, about 12 MHz to about 20 MHz, about 14 MHz to about 16 MHz, about 14 MHz to about 18 MHz, about 14 MHz to about 20 MHz, about 16 MHz to about 18 MHz, about 16 MHz to about 20 MHz, or about 18 MHz to about 20 MHz. In some instances, the one or more frequencies for isolating and/or capturing one or more particles or one or more plurality of particles of up to about 500 nm diameter, may comprise a frequency of about 1 MHz, about 2 MHz, about 4 MHz, about 8 MHz, about 10 MHz, about 12 MHz, about 14 MHz, about 16 MHz, about 18 MHz, or about 20 MHz.

In some instances, the one or more frequencies for isolating and/or capturing one or more particles or one or more plurality of particles of up to about 500 nm diameter, may comprise a frequency of at least about 1 MHz, about 2 MHz, about 4 MHz, about 8 MHz, about 10 MHz, about 12 MHz, about 14 MHz, about 16 MHz, or about 18 MHz. In some instances, the one or more frequencies for isolating and/or capturing one or more particles or one or more plurality of particles of up to about 500 nm diameter, may comprise a frequency of at most about 2 MHz, about 4 MHz, about 8 MHz, about 10 MHz, about 12 MHz, about 14 MHz, about 16 MHz, about 18 MHz, or about 20 MHz.

In some embodiments, the first isolation area (201, 304) and the second isolation area (203, 318) may be in fluid communication, as shown in FIG. 2 and FIG. 3. In some instances, the first isolation area 201 and the second isolation area 203 may be adjacent as shown in FIG. 2. In some cases, the first isolation area 304 and the second isolation area 318 may be separated by a distance and connected in fluid communication with one or more channels (314, 316, 328, 330). In some instances, the one or more channels may comprise a fluid channel, configured to be in fluid communication with one or more of the first isolation area and/or the second isolation area. In some cases, the one or more channels (314, 328) may comprise a channel in fluid communication with one or more extraction and/or elution channel (316, 330), inlet (302), and/or outlet (332) of the device and/or system. In some cases, the extraction and/or elution channels may be configured to collect or obtain isolated particles and/or waste solution containing contaminate particles that are not isolated.

In some embodiments, the device and/or system (200, 300) as described in FIG. 2 and/or FIG. 3 may implement a method of isolating a first and second particle in spatially non-overlapping regions. In some instances, the method may comprise: (a) providing a fluid composition to a system and/or device (200, 300) where the fluid composition comprises a first particle and a second particle; and (b) applying a first frequency at a first region (216, 310) to isolate the first particle (204, 312); (c) and applying a second frequency at a second region (218, 324) to isolate a second particle (205, 326). In some cases, the device and/or systems (200, 300) may comprise an inlet (202, 302) configured to receive the fluid composition and direct the fluid composition to the first region (216, 310), and the second region (218, 324). In some instances, the first particle may comprise a first plurality of particles, and the second particle may comprise a second plurality of particles, described elsewhere herein. In some cases, steps (b) and (c) may be completed in any order. In some instances, the method may further comprise providing a washing buffer and/or washing solution to the system and/or device after step (c) to wash away a remaining fraction of the fluid composition not isolated in the first region and the second region. In some cases, the device and/or system (200, 300), may comprise an outlet (214, 332), configured to elute and/or output the isolated first particle and/or second particle. In some instances, the method may further comprise removing the first frequency at the first region (216, 310) to elute and/or output the first particle. The method may further comprise removing a second frequency at the second region (218, 324) to elute and/or output the second particle. In some cases, removing the first frequency and removing the second frequency may occur in any order. The method may further comprise providing an eluant, buffer, and/or solution to elute the first particle and/or second particle after removing the first and/or second frequency. In some instances, the eluant, buffer and/or solution to elute the first particle and/or the second particle may be collected through connecting one or more fluid channels (314, 328) and/or one or more extraction and/or elution channels (316, 330).

### Modification of Membrane Permittivity

In some cases, the particles may comprise membrane-permittivity modified particles where the permittivity of particles with diameters of at least 1.8 μm are modified to aid with isolating larger particle sizes that would otherwise not be isolated with frequency alone, as described elsewhere herein. In some cases, the permittivity of particles may be modified by altering the particles capacitance. In some instances, membrane-permittivity modified particles may allow for precise targeting of particle isolation by selecting membrane-permittivity modifiers tailored to specific particles. In some cases, membrane-permittivity modified particles may be combined with other spatial and temporal frequency-based particle isolation, described elsewhere herein. Modification of membrane permittivity may be applicable for isolation, separation, characterization, and/or extraction of particles (e.g., membrane-bound particles) in media, where the media includes mid (e.g., 0.1-10 mM salt solution) to high ionic strength media (e.g., media with at least 10 mM sat solution).

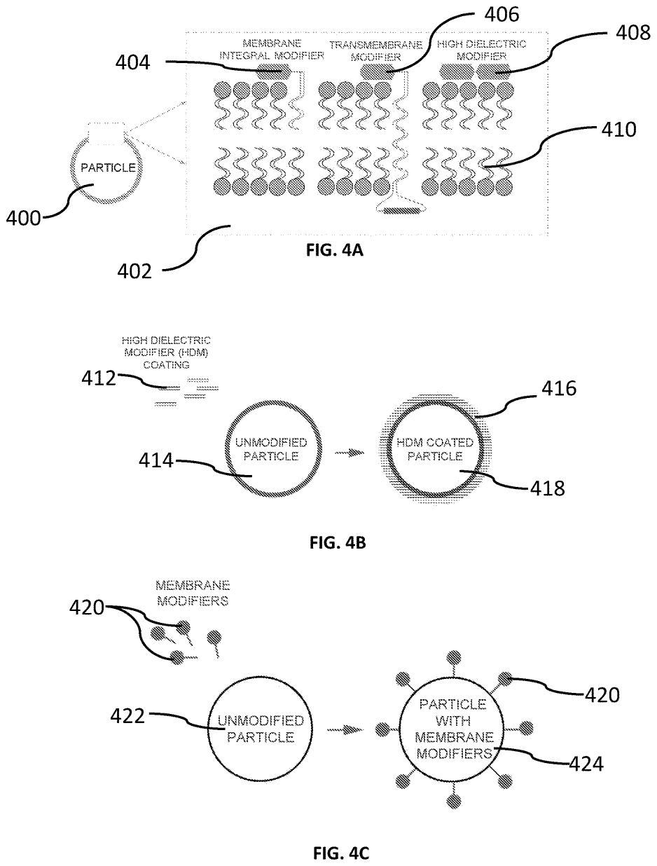

In some cases, the membrane-permittivity of particles 400 may be modified by one or more membrane permittivity modifiers (MPM) 402, for example, introduction of membrane integral 404 or transmembrane structures 406 into a particles membrane 410 that have proteins or lipid components which are highly charged as shown in FIG. 4A. In some cases, the MPM may comprise a high dielectric constant 408 or may be connected to synthetic polymers or conjugated polymers, described elsewhere herein, with high dielectric constants, also shown in FIG. 4A. In some cases, the modification of the membrane permittivity may be modified by coating 416 a surface of a particle 414 with synthetic polymers or conjugated polymers (412), micro ceramics (412), or other materials (412), resulting in a high dielectric modifier (HDM) coated particle 418, as shown in FIG. 4B.

In some cases, the material used to coat 416 the surface of the particle may comprise a dielectric constant (i.e., relative permittivity) of about 100 to about 1,000,000 when measured at 1 kHz with a traditional method. In some cases, the material used to coat 416 the surface of the particle may comprise a dielectric constant of about 100 to about 200, about 100 to about 400, about 100 to about 500, about 100 to about 1,000, about 100 to about 5,000, about 100 to about 10,000, about 100 to about 20,000, about 100 to about 50,000, about 100 to about 100,000, about 100 to about 500,000, about 100 to about 1,000,000, about 200 to about 400, about 200 to about 500, about 200 to about 1,000, about 200 to about 5,000, about 200 to about 10,000, about 200 to about 20,000, about 200 to about 50,000, about 200 to about 100,000, about 200 to about 500,000, about 200 to about 1,000,000, about 400 to about 500, about 400 to about 1,000, about 400 to about 5,000, about 400 to about 10,000, about 400 to about 20,000, about 400 to about 50,000, about 400 to about 100,000, about 400 to about 500,000, about 400 to about 1,000,000, about 500 to about 1,000, about 500 to about 5,000, about 500 to about 10,000, about 500 to about 20,000, about 500 to about 50,000, about 500 to about 100,000, about 500 to about 500,000, about 500 to about 1,000,000, about 1,000 to about 5,000, about 1,000 to about 10,000, about 1,000 to about 20,000, about 1,000 to about 50,000, about 1,000 to about 100,000, about 1,000 to about 500,000, about 1,000 to about 1,000,000, about 5,000 to about 10,000, about 5,000 to about 20,000, about 5,000 to about 50,000, about 5,000 to about 100,000, about 5,000 to about 500,000, about 5,000 to about 1,000,000, about 10,000 to about 20,000, about 10,000 to about 50,000, about 10,000 to about 100,000, about 10,000 to about 500,000, about 10,000 to about 1,000,000, about 20,000 to about 50,000, about 20,000 to about 100,000, about 20,000 to about 500,000, about 20,000 to about 1,000,000, about 50,000 to about 100,000, about 50,000 to about 500,000, about 50,000 to about 1,000,000, about 100,000 to about 500,000, about 100,000 to about 1,000,000, or about 500,000 to about 1,000,000 when measured at 1 kHz with a traditional method. In some cases, the material used to coat 416 the surface of the particle may comprise a dielectric constant of about 100, about 200, about 400, about 500, about 1,000, about 5,000, about 10,000, about 20,000, about 50,000, about 100,000, about 500,000, or about 1,000,000 when measured at 1 kHz with a traditional method. In some cases, the material used to coat 416 the surface of the particle may comprise a dielectric constant of at least about 100, about 200, about 400, about 500, about 1,000, about 5,000, about 10,000, about 20,000, about 50,000, about 100,000, about 500,000, about 1,000,000 when measured at 1 kHz with a traditional method. In some cases, the material used to coat 416 the surface of the particle may comprise a dielectric constant of at most about 200, about 400, about 500, about 1,000, about 5,000, about 10,000, about 20,000, about 50,000, about 100,000, about 500,000, or about 1,000,000 when measured at 1 kHz with a traditional method.

In some cases, the material used to coat 416 the surface of the particle may comprise a dielectric constant (i.e., relative permittivity) of about 10,000 to about 100,000,000,000 when measured at 1 kHz using Equation 2. In some cases, the material used to coat 416 the surface of the particle may comprise a dielectric constant of about 10,000 to about 25,000, about 10,000 to about 50,000, about 10,000 to about 100,000, about 10,000 to about 250,000, about 10,000 to about 500,000, about 10,000 to about 1,000,000, about 10,000 to about 10,000,000, about 10,000 to about 100,000,000, about 10,000 to about 1,000,000,000, about 10,000 to about 10,000,000,000, about 10,000 to about 100,000,000,000, about 25,000 to about 50,000, about 25,000 to about 100,000, about 25,000 to about 250,000, about 25,000 to about 500,000, about 25,000 to about 1,000,000, about 25,000 to about 10,000,000, about 25,000 to about 100,000,000, about 25,000 to about 1,000,000,000, about 25,000 to about 10,000,000,000, about 25,000 to about 100,000,000,000, about 50,000 to about 100,000, about 50,000 to about 250,000, about 50,000 to about 500,000, about 50,000 to about 1,000,000, about 50,000 to about 10,000,000, about 50,000 to about 100,000,000, about 50,000 to about 1,000,000,000, about 50,000 to about 10,000,000,000, about 50,000 to about 100,000,000,000, about 100,000 to about 250,000, about 100,000 to about 500,000, about 100,000 to about 1,000,000, about 100,000 to about 10,000,000, about 100,000 to about 100,000,000, about 100,000 to about 1,000,000,000, about 100,000 to about 10,000,000,000, about 100,000 to about 100,000,000,000, about 250,000 to about 500,000, about 250,000 to about 1,000,000, about 250,000 to about 10,000,000, about 250,000 to about 100,000,000, about 250,000 to about 1,000,000,000, about 250,000 to about 10,000,000,000, about 250,000 to about 100,000,000,000, about 500,000 to about 1,000,000, about 500,000 to about 10,000,000, about 500,000 to about 100,000,000, about 500,000 to about 1,000,000,000, about 500,000 to about 10,000,000,000, about 500,000 to about 100,000,000,000, about 1,000,000 to about 10,000,000, about 1,000,000 to about 100,000,000, about 1,000,000 to about 1,000,000,000, about 1,000,000 to about 10,000,000,000, about 1,000,000 to about 100,000,000,000, about 10,000,000 to about 100,000,000, about 10,000,000 to about 1,000,000,000, about 10,000,000 to about 10,000,000,000, about 10,000,000 to about 100,000,000,000, about 100,000,000 to about 1,000,000,000, about 100,000,000 to about 10,000,000,000, about 100,000,000 to about 100,000,000,000, about 1,000,000,000 to about 10,000,000,000, about 1,000,000,000 to about 100,000,000,000, or about 10,000,000,000 to about 100,000,000,000 when measured at 1 kHz using Equation 2. In some cases, the material used to coat 416 the surface of the particle may comprise a dielectric constant of about 10,000, about 25,000, about 50,000, about 100,000, about 250,000, about 500,000, about 1,000,000, about 10,000,000, about 100,000,000, about 1,000,000,000, about 10,000,000,000, or about 100,000,000,000 when measured at 1 kHz using Equation 2. In some cases, the material used to coat 416 the surface of the particle may comprise a dielectric constant of at least about 10,000, about 25,000, about 50,000, about 100,000, about 250,000, about 500,000, about 1,000,000, about 10,000,000, about 100,000,000, about 1,000,000,000, about 10,000,000,000, or about 100,000,000,000 when measured at 1 kHz using Equation 2. In some cases, the material used to coat 416 the surface of the particle may comprise a dielectric constant of at most about 25,000, about 50,000, about 100,000, about 250,000, about 500,000, about 1,000,000, about 10,000,000, about 100,000,000, about 1,000,000,000, about 10,000,000,000, or about 100,000,000,000 when measured at 1 kHz using Equation 2.

In some instances, the modification of the membrane permittivity may be modified by attached nanoparticles 420 (e.g., 1 nm-200 nm diameter nanoparticles depending on the size of the particle to be isolated), described elsewhere herein, to the surface of the particle 422, resulting in a particle with membrane modifiers attached to a surface of the particle 424, as shown in FIG. 4C. The nanoparticles may be synthetic or biological, e.g., forms of drug delivery nanovesicles that have membranes, gold, or other synthetic nanoparticles with high dielectric constants at low frequencies (up to 1 MHz). The nanoparticles may be coupled to membrane proteins on the surface of the desired particle (e.g., cell, extracellular vesicle, or bodies) by aptamer or antibody binding in solution. Once bound to a surface of a particle, the nanoparticles may modify the overall dielectric constant of the particle and the bound nanoparticle to assist with isolating and/or extracting the particles from solution.

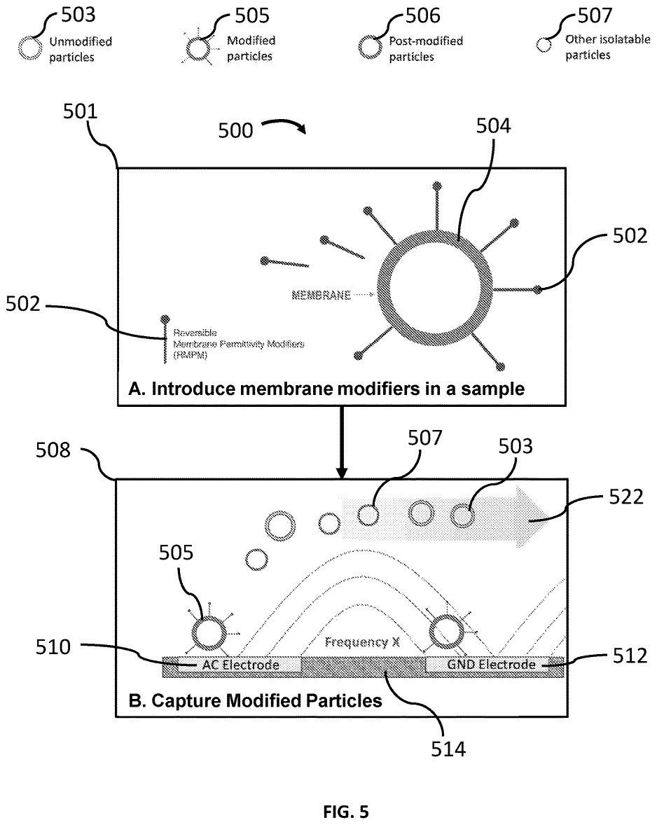

In some instances, the disclosure provided herein describes a method of isolating a modified a membrane-permittivity particle 500, as seen in FIG. 5. In some cases, the method may comprise: providing a fluid sample comprising one or more particles and/or a plurality of particles 504 and a membrane-permittivity modifier 502, wherein the membrane-permittivity modifier is configured to couple to the particle (step 501); applying a frequency configured to attract and/or isolate the first particle or the first plurality of membrane-permittivity modified particles towards one or more electrodes (510, 512) (step 508); and providing a washing solution and/or buffer 522 to remove or elute non-isolated particles (e.g., other isolatable particles 507 and/or unmodified particles 503) (step 508). The method may further comprise removing the frequency and providing a second washing solution and/or buffer to remove or elute the membrane-permittivity modified particles 505. In some cases, the one or more electrodes may comprise a signal electrode 510 or a sink electrode 512, described elsewhere herein. In some instances, the one or more electrodes may be coupled to a chip 514 configured to conduct and/or detect signals and to conduct further downstream analysis of the isolate particle or plurality of particles. In some cases, the one or more particles and/or the plurality of particles may comprise a plurality of first particles and a plurality of second particles. In some instances, the plurality of first particles and the plurality of second particles may comprise different sizes, described elsewhere herein.

In some cases, the particles may comprise reversible membrane permittivity modifiers (RMPM). In some cases, RMPM may comprise transmembrane and/or membrane integral proteins membrane coating conductive materials, and/or nanoparticles, described elsewhere herein. In some cases, RMPM may modify particle permittivity to aid with particle isolation and may then be reversed to revert the particle back to its original form for further processing. RMPM may be reversed or removed from particles by breaking a bond between the RMPM and the particle using e.g., heat, enzymes, or any combination thereof.

In some instances, the disclosure provided herein describes a method of modifying a particle with a reversible modifier of membrane permittivity. In some cases, the method may comprise: providing a RMPM to a fluid sample, where the fluid sample may comprise a first particle configured to couple to the RMPM; applying frequency to the fluid sample comprising the first particle coupled to the RMPM, where the frequency is configured to attract or isolate the first particle coupled to the RMPM to a region of an electrode emitting the frequency; washing the isolated particles to remove non-isolated particles of the fluid sample; decoupling the RMPM coupled to the particle with a modifier-specific approach (e.g., heat, enzyme, etc.); and eluting or extracting the RMPM-free particles with an extraction buffer.

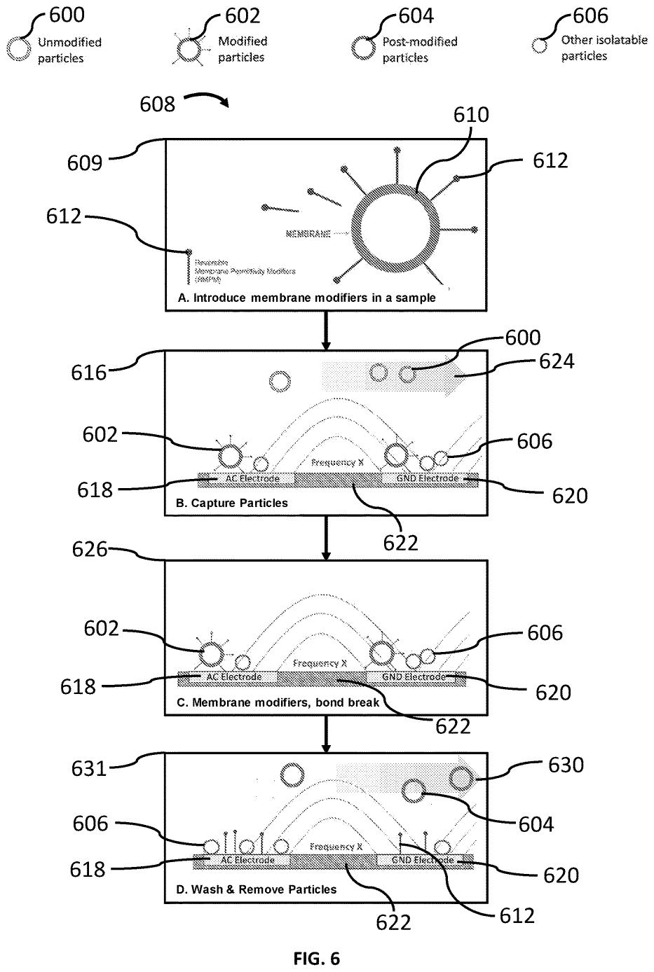

In some cases, the disclosure provided herein describes a method of modifying a particle with a reversible modifier of membrane permittivity 608, as seen in FIG. 6. In some cases, the method may comprise: providing a RMPM 612 to a fluid sample, where the fluid sample may comprise a particle 610 configured to couple to the RMPM (step 609); applying a frequency to the fluid sample comprising the first particle coupled to the RMPM, where the frequency is configured to attract or isolate the a subset of particles 606 including the particle coupled to the RMPM 602 to a region of an signal electrode 618 and/or sink electrode 620 on a chip 622 (step 616); washing 624 the isolated subset of particles (602, 606) to remove non-isolated un modified particles 600 of the fluid sample (step 616); breaking the bond of the RMPM coupled to the particle 602 with a modifier-specific approach (e.g., heat, enzyme, etc.) (step 626); and eluting or extracting 630 the RMPM-free particles 604 with an extraction buffer (step 631). In some cases, the method may further comprise isolating one or more other particles 606 by removing the applied frequency and introducing a second extraction buffer to elute and/or extract the one or more other particles 606 isolated.

In some instances, the disclosure provided herein describes a method of a multi-target particle same-run isolation 700, as seen in FIG. 7. In some cases, the method may comprise: providing a fluid solution comprising one or more first particles (e.g., unmodified particles of at least 2 μm diameter 703), second particles (e.g., membrane permittivity modified particles 702), third particle (e.g., unmodified particles up to 2 μm 704), fourth particles (e.g., small particles such as extracellular vesicles and/or exosomes 706), or any combination thereof to a chip 708 (step 701); applying a first frequency to the fluid solution by one or more electrodes (710, 712) thereby isolating the one or more second, third, and fourth particles of the fluid solution on the one or more electrodes (710, 712) (step 701); providing a wash buffer and/or eluting solution 714 to extract and/or elute the first particle (703) (step 701); applying a second frequency to the fluid solution by the one or more electrodes (710, 712), where the first frequency and the second frequency differ, thereby isolating the one or more third (704) and fourth (706) particles of the fluid solution on the one or more electrodes (710, 712) and releasing one or more second particles (702) (step 718); providing a wash buffer and/or eluting solution 714 to extract and/or elute the one or more second particles (702) (step 718); applying a third frequency by the one or more electrodes (710, 712), where the third frequency differs from the first and second frequencies, and where application of the third frequency isolates the one or more fourth particles (706) on the one or more electrodes (710, 712) and releases the one or more third particles (704) (step 720); providing a wash buffer and/or eluting solution 714 to extract and/or elute the one or more third particles (704) (step 720); removing and/or releasing the third frequency thereby releasing the one or more fourth particles (706) (step 722); and providing a wash buffer and/or eluting solution 714 to extract and/or elute the one or more fourth particles (706) (step 722).

### Predictive Models & Machine Learning

The methods, devices and/or systems of the present disclosure may utilize or access external capabilities of artificial intelligence, predictive models, and/or machine learning techniques to identify one or more frequencies and/or one or more frequency ranges to isolate one or more particles or one or more plurality of particles of a fluid sample. In some cases, the artificial intelligence and/or predictive models' techniques may identify features of the one or more particles from sensor data collected by the one or more sensors, described elsewhere herein, to apply one or more frequencies and/or one or more frequency ranges to isolate or attract the one or more particles and/or one or more plurality of particles towards one or more electrodes, described elsewhere herein. In some cases, the sample media characteristics (e.g., ionic strength, type) may be used as features. In some cases, the features may be used to train one or more predictive models and/or machine learning algorithms, described elsewhere herein. In some instances, data, e.g., shown in FIGS. 9A-9D may be used to initially train one or more predictive models and/or machine learning algorithms that may then be improved (e.g., increase in accuracy of the model) over time when new data is collected and provided for training. These features may be used to isolate one or more particles and/or one or more plurality of particles from a fluid composition with minimal to no contamination. Using such a predictive model and/or artificial intelligence, it may not be necessary to have a priori knowledge of the particle size or range of particles sizes to isolate the one or more particles and/or one or more plurality of particles of the fluid composition with minimal artifact or contamination.

The methods and systems of the present disclosure may analyze sensor data and fluid media ionic strength to determine one or more frequencies and/or one or more frequency ranges to isolate one or more particles and/or one or more plurality of particles. In some cases, the methods, and systems, described elsewhere herein, may train a predictive model with one or more particles' size, media ionic strength, with a corresponding training label of particle sizes eluted and/or extracted. In some cases, the trained predictive model may be used to generate a likelihood (e.g., a prediction) of the one or more frequencies to be applied to isolate one or more particles and/or one or more plurality of particles based on an input of the detected particle size by the one or more sensors, described elsewhere herein.

The trained predictive model may comprise an artificial intelligence-based model, such as a machine learning based classifier, configured to process the measured size of the one or more particles and/or the one or more plurality of particles (provided by the one or more sensors) to generate one or more particle isolation frequencies and/or one or more ranges of particle isolation frequencies.

The model may comprise one or more predictive models. The model may comprise one or more machine learning algorithms. Examples of machine learning algorithms may include a support vector machine (SVM), a naive Bayes classification, a random forest, a neural network (such as a deep neural network (DNN), a recurrent neural network (RNN), a deep RNN, a long short-term memory (LSTM) recurrent neural network (RNN), a gated recurrent unit (GRU), a gradient boosting machine, a random forest, or other supervised learning algorithm or unsupervised machine learning, statistical, linear regression, k-nearest neighbors, k-means, decision tree, logistic regression, or any combination thereof. The model may be used for classification or regression. The model may likewise involve the estimation of ensemble models, comprised of multiple predictive models, and utilize techniques such as gradient boosting, for example in the construction of gradient-boosting decision trees. The model may be trained using frequency applied to isolate the one or more particles and/or plurality of particles, sensor particle size measurement, particle media ionic strength, particle sizes eluted and/or extracted after isolation, or a combination thereof.

The model may comprise one or more neural networks, such as a neural network, a convolutional neural network (CNN), a deep neural network (DNN), a recurrent neural network (RNN), or a deep RNN. The recurrent neural network may comprise units which can be long short-term memory (LSTM) units or gated recurrent units (GRU). Neural network techniques, such as dropout or regularization, may be used during training the model to prevent overfitting. The neural network may comprise a plurality of sub-networks, each of which is configured to generate a classification or prediction of a different type of output information (e.g., which may be combined to form an overall output of the neural network). The machine learning model may alternatively utilize statistical or related algorithms including random forest, classification and regression trees, support vector machines, discriminant analyses, regression techniques, as well as ensemble and gradient-boosted variations thereof.

Input training features may be structured by aggregating the data into bins or alternatively using a one-hot encoding. Inputs may also include feature values or vectors derived from the previously mentioned inputs, such as cross-correlations.

The model may process the input features to generate output values comprising the one or more frequencies and/or frequency ranges to be applied to the one or more electrodes to isolate one or more particles and/or one or more plurality of particles of a fluid composition.

Various machine learning techniques may cascade such that the output of a machine learning technique may also be used as input features to subsequent layers or subsections of the model.

In order to train the model (e.g., by determining weights and correlations of the model) to generate real-time classifications or predictions, the model can be trained using datasets, described elsewhere herein. Such datasets may be sufficiently large to generate statistically significant classifications or predictions.

Datasets may be split into subsets of datasets, such as a training dataset, a development dataset, and a test dataset. For example, a dataset may be split into a training dataset comprising 80% of the dataset, a development dataset comprising 10% of the dataset, and a test dataset comprising 10% of the dataset. The training dataset may comprise about 10%, about 20%, about 30%, about 40%, about 50%, about 60%, about 70%, about 80%, or about 90% of the dataset. The development dataset may comprise about 10%, about 20%, about 30%, about 40%, about 50%, about 60%, about 70%, about 80%, or about 90% of the dataset. The test dataset may comprise about 10%, about 20%, about 30%, about 40%, about 50%, about 60%, about 70%, about 80%, or about 90% of the dataset. In some embodiments, leave one out cross validation may be employed.

To improve the accuracy of model predictions and reduce overfitting of the model, the datasets may be augmented to increase the number of samples within the training set. For example, data augmentation may comprise rearranging the order of observations in a training record. To accommodate datasets having missing observations, methods to impute missing data may be used, such as forward-filling, back-filling, linear interpolation, and multi-task Gaussian processes. Datasets may be filtered, or batch corrected to remove or mitigate confounding factors.

When the model generates a classification or a prediction of the one or more frequencies and/or one or more frequency ranges to isolate one or more particles and/or one or more plurality of particles, a notification (e.g., alert or alarm) may be generated and transmitted to an operator, on the device and/or system user interface, described elsewhere herein. Notifications may be transmitted via an automated phone call, a short message service (SMS) or multimedia message service (MMS) message, an e-mail, or an alert within a dashboard. The notification may comprise output information such as particle size distribution and recommended and/or predicted frequency to apply to isolate the particles.

To validate the performance of the model, different performance metrics may be generated. For example, an area under the receiver-operating characteristic curve (AUROC) may be used to determine the diagnostic capability of the model. For example, the model may use classification thresholds which are adjustable, such that specificity and sensitivity are tunable, and the receiver-operating characteristic curve (ROC) can be used to identify the different operating points corresponding to different values of specificity and sensitivity.

In some cases, such as when datasets are not sufficiently large, cross-validation may be performed to assess the robustness of a model across different training and testing datasets.

To calculate performance metrics such as sensitivity, specificity, accuracy, positive predictive value (PPV), negative predictive value (NPV), area under the precision-recall curve (AUPR), AUROC, or similar, the following definitions may be used. A “false positive” may refer to an outcome in which a positive outcome or result has been incorrectly or prematurely generated (e.g., predicting that a particle of a type and/or a size is present in a fluid sample but there is no presence of the particle in the fluid sample). A “true positive” may refer to an outcome in which positive outcome or result has been correctly generated (e.g., a particle of a type and/or size determined to be present in a fluid sample is indeed isolated and present in the fluid sample). A “false negative” may refer to an outcome in which a negative determination of the presence of a particle type and/or size is made where the one or more particle and/or plurality of particles with the type or size are present in the fluid sample. A “true negative” may refer to an outcome in which a negative outcome or result has been generated (e.g., the lack of the presence of one or more particles and/or one or more plurality of particles of a type, size and/or size range).

The model may be trained until certain pre-determined conditions for accuracy or performance are satisfied, such as having minimum desired contamination of isolated particles and/or highest isolation of one or more particles and/or one or more plurality of particles. Examples of predictive accuracy and target one or more particle and/or target one or more plurality of particle isolation may include sensitivity, specificity, positive predictive value (PPV), negative predictive value (NPV), accuracy, AUPR, and AUROC.

The sensitivity of predicting the one or more frequencies and/or one or more ranges of frequencies to isolate one or more particles and/or one or more plurality of particles may comprise a value of, for example, at least about 50%, at least about 55%, at least about 60%, at least about 65%, at least about 70%, at least about 75%, at least about 80%, at least about 85%, at least about 90%, at least about 95%, at least about 96%, at least about 97%, at least about 98%, or at least about 99%.

The specificity of predicting the one or more frequencies and/or one or more ranges of frequencies to isolate one or more particles and/or one or more plurality of particles may comprise a value of, for example, at least about 50%, at least about 55%, at least about 60%, at least about 65%, at least about 70%, at least about 75%, at least about 80%, at least about 85%, at least about 90%, at least about 95%, at least about 96%, at least about 97%, at least about 98%, or at least about 99%.

The positive predictive value (PPV) of predicting the one or more frequencies and/or one or more ranges of frequencies to isolate one or more particles and/or one or more plurality of particles may comprises a value of, for example, at least about 50%, at least about 55%, at least about 60%, at least about 65%, at least about 70%, at least about 75%, at least about 80%, at least about 85%, at least about 90%, at least about 95%, at least about 96%, at least about 97%, at least about 98%, or at least about 99%.

The negative predictive value (NPV) of predicting the one or more frequencies and/or one or more ranges of frequencies to isolate one or more particles and/or one or more plurality of particles may comprises a value of, for example, at least about 50%, at least about 55%, at least about 60%, at least about 65%, at least about 70%, at least about 75%, at least about 80%, at least about 85%, at least about 90%, at least about 95%, at least about 96%, at least about 97%, at least about 98%, or at least about 99%.

The area under the curve (AUC) of a Receiver Operating Characteristic (ROC) curve (AUROC) of predicting the one or more frequencies and/or one or more ranges of frequencies to isolate one or more particles and/or one or more plurality of particles may comprise a value of at least about 0.50, at least about 0.55, at least about 0.60, at least about 0.65, at least about 0.70, at least about 0.75, at least about 0.80, at least about 0.85, at least about 0.90, at least about 0.95, at least about 0.96, at least about 0.97, at least about 0.98, or at least about 0.99.

The area under the precision-recall curve (AUPR) of predicting the one or more frequencies and/or one or more ranges of frequencies to isolate one or more particles and/or one or more plurality of particles may comprises a value of at least about 0.10, at least about 0.15, at least about 0.20, at least about 0.25, at least about 0.30, at least about 0.35, at least about 0.40, at least about 0.45, at least about 0.50, at least about 0.55, at least about 0.60, at least about 0.65, at least about 0.70, at least about 0.75, at least about 0.80, at least about 0.85, at least about 0.90, at least about 0.95, at least about 0.96, at least about 0.97, at least about 0.98, or at least about 0.99.

In some embodiments, the trained model may be trained or configured to predict the one or more frequencies and/or one or more ranges of frequencies to isolate one or more particles and/or one or more plurality of particles with a sensitivity of at least about 50%, at least about 55%, at least about 60%, at least about 65%, at least about 70%, at least about 75%, at least about 80%, at least about 85%, at least about 90%, at least about 95%, at least about 96%, at least about 97%, at least about 98%, or at least about 99%.

In some embodiments, the trained model may be trained or configured to predict the one or more frequencies and/or one or more ranges of frequencies to isolate one or more particles and/or one or more plurality of particles with a specificity of at least about 50%, at least about 55%, at least about 60%, at least about 65%, at least about 70%, at least about 75%, at least about 80%, at least about 85%, at least about 90%, at least about 95%, at least about 96%, at least about 97%, at least about 98%, or at least about 99%.

In some embodiments, the trained model may be trained or configured to predict the one or more frequencies and/or one or more ranges of frequencies to isolate one or more particles and/or one or more plurality of particles with a positive predictive value (PPV) of at least about 50%, at least about 55%, at least about 60%, at least about 65%, at least about 70%, at least about 75%, at least about 80%, at least about 85%, at least about 90%, at least about 95%, at least about 96%, at least about 97%, at least about 98%, or at least about 99%.

In some embodiments, the trained model may be trained or configured to predict the one or more frequencies and/or one or more ranges of frequencies to isolate one or more particles and/or one or more plurality of particles with a negative predictive value (NPV) of at least about 50%, at least about 55%, at least about 60%, at least about 65%, at least about 70%, at least about 75%, at least about 80%, at least about 85%, at least about 90%, at least about 95%, at least about 96%, at least about 97%, at least about 98%, or at least about 99%.

In some embodiments, the trained model may be trained or configured to predict the one or more frequencies and/or one or more ranges of frequencies to isolate one or more particles and/or one or more plurality of particles with an area under the curve (AUC) of a Receiver Operating Characteristic (ROC) curve (AUROC) of at least about 0.50, at least about 0.55, at least about 0.60, at least about 0.65, at least about 0.70, at least about 0.75, at least about 0.80, at least about 0.85, at least about 0.90, at least about 0.95, at least about 0.96, at least about 0.97, at least about 0.98, or at least about 0.99.

In some embodiments, the trained model may be trained or configured to predict the one or more frequencies and/or one or more ranges of frequencies to isolate one or more particles and/or one or more plurality of particles with an area under the precision-recall curve (AUPR) of at least about 0.10, at least about 0.15, at least about 0.20, at least about 0.25, at least about 0.30, at least about 0.35, at least about 0.40, at least about 0.45, at least about 0.50, at least about 0.55, at least about 0.60, at least about 0.65, at least about 0.70, at least about 0.75, at least about 0.80, at least about 0.85, at least about 0.90, at least about 0.95, at least about 0.96, at least about 0.97, at least about 0.98, or at least about 0.99.

### Computer Systems

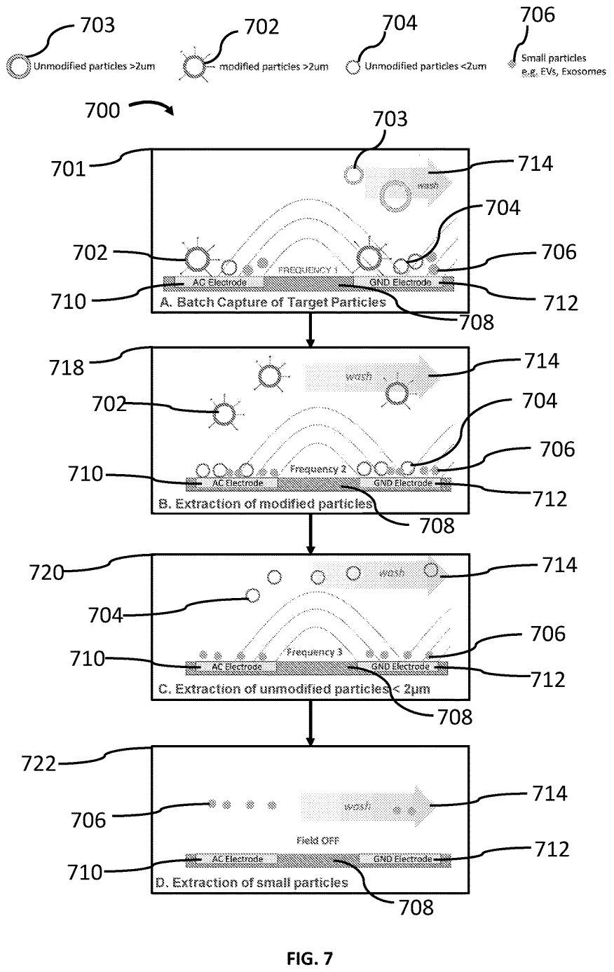

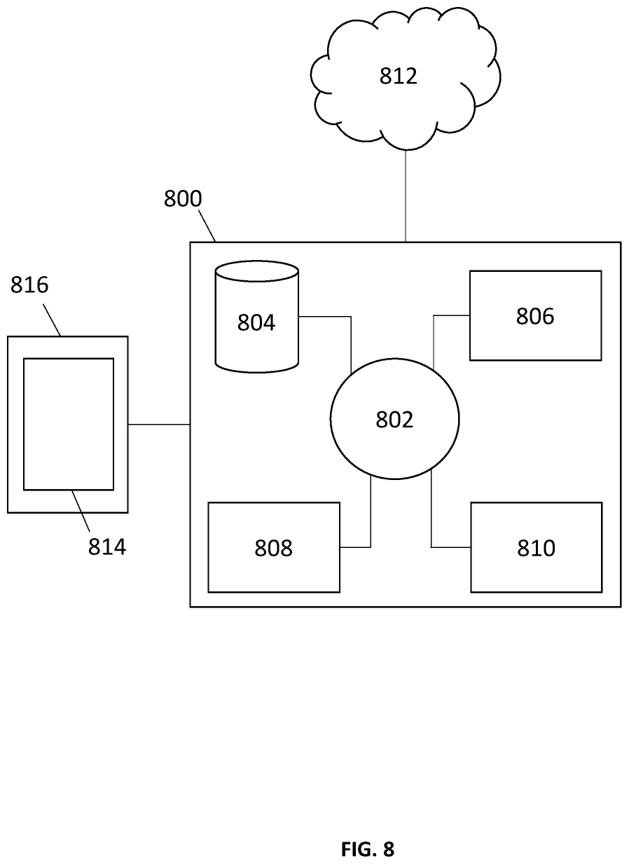

The present disclosure provides computer systems that are programmed to implement methods of the disclosure. FIG. 8 shows a computer system 800 that is programmed or otherwise configured to isolate one or more particles, described elsewhere herein. The computer system 800 can regulate various aspects of the frequency of the one or more electrodes, described elsewhere herein to isolate particles of various sizes of the present disclosure. In some instances, the computer systems may sense and/or detect a particle size (e.g., diameter) by one or more sensors and determine one or more frequencies to apply to isolate one or more particles on one or more electrodes. In some cases, the computer system may use a look up table of prior established frequencies configured to isolate or draw one or more particles to the one or more electrodes of the devices and/or systems described herein. In some cases, the computer systems may implement a predictive model, described elsewhere herein, configured to determine the appropriate one or more frequencies or frequency ranges to apply to the one or more electrodes. The computer system 800 can be an electronic device of a user or a computer system that is remotely located with respect to the electronic device. The electronic device can be a mobile electronic device.

The computer system 800 includes a central processing unit (CPU, also “processor” and “computer processor” herein) 802, which can be a single core or multi core processor, or a plurality of processors for parallel processing. The computer system 800 also includes memory or memory location 808 (e.g., random-access memory, read-only memory, flash memory), electronic storage unit 804 (e.g., hard disk), communication interface 810 (e.g., network adapter) for communicating with one or more other systems, and peripheral devices 806, such as cache, other memory, data storage and/or electronic display adapters. The memory 808, storage unit 804, interface 810 and peripheral devices 806 are in communication with the CPU 802 through a communication bus (solid lines), such as a motherboard. The storage unit 804 can be a data storage unit (or data repository) for storing data. The computer system 800 can be operatively coupled to a computer network (“network”) 812 with the aid of the communication interface 810. The network 812 can be the Internet, an internet and/or extranet, or an intranet and/or extranet that is in communication with the Internet. The network 812 in some cases is a telecommunication and/or data network. The network 812 can include one or more computer servers, which can enable distributed computing, such as cloud computing. The network 812, in some cases with the aid of the computer system 800, can implement a peer-to-peer network, which may enable devices coupled to the computer system 800 to behave as a client or a server.

The CPU 802 can execute a sequence of machine-readable instructions, which can be embodied in a program or software. The instructions may be stored in a memory location, such as the memory 808. The instructions can be directed to the CPU 802, which can subsequently program or otherwise configure the CPU 802 to implement methods of the present disclosure. Examples of operations performed by the CPU 802 can include fetch, decode, execute, and writeback.

The CPU 802 can be part of a circuit, such as an integrated circuit. One or more other components of the system 800 can be included in the circuit (e.g., the chip of the systems and/or devices, described elsewhere herein). In some cases, the circuit is an application specific integrated circuit (ASIC).

The storage unit 804 can store files, such as drivers, libraries, and saved programs. The storage unit 804 can store user data, e.g., user preferences and user programs. The computer system 800 in some cases can include one or more additional data storage units that are external to the computer system 800, such as located on a remote server that is in communication with the computer system 800 through an intranet or the Internet.

The computer system 800 can communicate with one or more remote computer systems through the network 812. For instance, the computer system 800 can communicate with a remote computer system of a user. Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 800 via the network 812.

Methods as described herein can be implemented by way of machine (e.g., computer processor) executable code stored on an electronic storage location of the computer system 800, such as, for example, on the memory 808 or electronic storage unit 804. The machine executable or machine-readable code can be provided in the form of software. During use, the code can be executed by the processor 802. In some cases, the code can be retrieved from the storage unit 804 and stored on the memory 808 for ready access by the processor 802. In some situations, the electronic storage unit 804 can be precluded, and machine-executable instructions are stored on memory 808.

The code can be pre-compiled and configured for use with a machine having a processer adapted to execute the code or can be compiled during runtime. The code can be supplied in a programming language that can be selected to enable the code to execute in a pre-compiled or as-compiled fashion.

Aspects of the systems and methods provided herein, such as the computer system 700, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as the main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 800 can include or be in communication with an electronic display 816 that comprises a user interface (UI) 814 for providing, for example, user views to select the type of sample provided to the device and/or systems described here, live video and/or still images taken of the isolation of the particles on the device, device operating characteristics (e.g., pressure within the device, sensor values, frequency emitted, etc.), the measured outcome of the particles isolated, or any combination thereof. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit 802. The algorithm can, for example, determine the one or more frequencies or one or more frequency ranges to apply to the one or more electrodes to isolate one or more particles. The algorithm may determine the one or more frequencies or one or more frequency ranges from sensor values and a lookup table of sensor value mapped to one or more frequencies, or one or more frequency ranges configured to one or more particles of a measured sensor value.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. It will be obvious to those skilled in the art that such embodiments are provided by way of example only. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables.

It should be understood that various alternatives to the embodiments of the invention described herein may be employed in practicing the invention. It is therefore contemplated that the invention shall also cover any such alternatives, modifications, variations, or equivalents. It is intended that the following claims define the scope of the invention and that methods and structures within the scope of these claims and their equivalents be covered thereby.

### EXAMPLES

### Example 1: Use of DASH Method to Generate Predictions Library of Particle-Specific Dielectric Profiles for Synthetic Particles with and without Modified Membranes

With continuing advancement in drug nanocarriers, it is important to develop a methodology that uses experimental data to predict feasibility of isolation of these nanoparticles in different solutions. One of the most common modifications of synthetic particles includes modification of their surface, such as coating or functionalization. As a result, it is critical to understand how such modifications affect isolation feasibility of these particles. An experiment was conducted to demonstrate feasibility of reducing the theoretical basis behind the DASH methodology to practice by generating a library of predicted particle- and matrix-specific dielectric profiles.

In order to demonstrate feasibility of building a DASH-based permittivity prediction library for synthetic particles, a simple and traceable methodology of measuring particle's permittivity and comparing it with DASH theoretical approach was developed and demonstrated in FIGS. 9A-9D. In general, the approach consisted of the following steps: (1) experimental measurements of real-time complex impedance of fluids containing highly conductive (gold) and highly insulative (silica) particles in a low ionic strength solution (deionized (DI) water), (2) converting recorded impedance data into real capacitance, (3) using experimental data, in combination with particle and solution-specific parameters to generate estimates of effective permittivity of the particles under experimental conditions and (4) generating predictions of the feasibility of capturing the particles on electrodes in a standard high salinity buffer commonly used in biomedical experiments.

A Reference 620 potentiostat from Gamry Instruments (Warminster, PA) was used for all the measurements of complex impedance described in this Example. The potentiostat was attached by connectors to an open-ended coaxial cable which was connected to a standard F Male to BNC Female adapter (RF Industries, San Diego, CA) which could fit up to 300 μL fluid. The potentiostat was used in the EIS Spectroscopic measurement mode where a voltage of 20 mV was applied to the coaxial cable and the subsequent current was measured. The impedance was measured and automatically recorded for each of 45 logarithmically spaced points across a range from 100 Hz to 3 MHz. The upper bound of frequency (3 MHz) was chosen experimentally as the highest frequency the instrument was able to measure consistently. Each fluid sample was measured on a dedicated adaptor to eliminate the possibility of cross-contamination.

The following solutions were created and tested over the course of the experiment:
Solution A. Background de-ionized water. De-ionized water was purchased from Sigma Aldrich (St. Louis, US); 300 μL was pipetted into the open-ended coaxial cable;
Solution B. Silica nanoparticles mix. Silica nanoparticles (150 nm) were purchased from Sigma Aldrich (St. Louis, US); and were diluted to 1% solids. 30 μL of this dilution was then inputted into the coaxial cable along with 270 μL of the de-ionized water described above.
Solution C. Gold coated silica nanoparticles mix. Silica nanoparticles with gold nanoparticles covalently bonded to the surface were purchased from Sigma Aldrich (St. Louis, US); and were diluted to 1% solids and then 30 μL of this dilution was then pipetted into the coaxial cable along with 270 μL of the de-ionized water described above.
Solution D. Gold particles mix. Finally, 23.75 k gold flakes were purchased from Barnabas Gold (Kwun Tong, Hong Kong) and then mixed and vortexed in deionized water. 30 μL of this solution was input into the coaxial cable.

All measurements were taken in triplicate. If any outliers were present in the measurement, the sample was measured again or remade until 3 consistent results were obtained. For the calculation of real capacitance, experimental impedance measurements were exported into Excel, where the following equation was used to convert complex impedance into real capacitance:

$${C}_{real} = - \frac{{z}_{imag}}{ω ( {Z}_{real}^{2} + {Z}_{imag}^{2} )}$$

In order to estimate effective permittivity of the particles and the surrounding fluid, we calculated capacitance of the particles without the fluid background and then used particle-specific parameters to calculate their effective permittivity. The capacitance of background water (Solution A) at each of the measured frequency points, was subtracted from each of the particle-containing Solutions B, C and D. The resulting capacitances at each of the measured frequency points were then plotted in FIG. 10A as a capacitance ladder. The particle capacitance was converted to permittivity via two methods. Method A, described in Equation 2, that was supplemented by a standard method (Method B), with both plotted in FIG. 10B and FIG. 10C, respectively.

We used Method A to generate predictions of particles' permittivity at the same frequency intervals as above and their resulting charge (positive/negative) in a high ionic strength buffer (100 mM). Shaded areas surrounded by dashed line in FIG. 10B and FIG. 10C outline the predicted “capture zone”, where at the indicated frequencies the particle's permittivity will be sufficient to affect CM to become positive, resulting in particles moving toward the source of electric field. Notably, the data demonstrated a predicted effect of changes in particle's permittivity due to its membrane modification with gold nanoparticles to the extent that modified particle would be capturable on electrodes at <1 MHz in both mid & high salt solutions (>0.1 mM ionic strength).

The experiment demonstrated the feasibility of using experimental data to develop a DASH based predictive isolation profiles for synthetic particles. The experiment also provided positive data pertaining to the feasibly of changing effective permittivity of highly insulative particles (silica) by modifying the silica particle membrane with one of the membrane permittivity modifiers (MPM), highly conductive gold nanoparticles. The ability to develop particle-specific isolation profiles and the ability to predict the behavior of particles with and without modifiers validate the performance of the method, described elsewhere herein, for both existing and future nanocarriers. The real-world use of particle-specific predictions are outlined in Examples 4 and 5 below.

### Example 2: Use of DASH Method to Generate Predictions Library of Particle-Specific Dielectric Profiles for Synthetic Particles of Subcellular (<1 μm) and Cellular Size (>1 μm)

With continuing expansion of the range of synthetic particles used in biomedical applications, it is important to develop a methodology that uses experimental data to predict feasibility of isolation of particles of different size ranges in different biological solutions. An experiment was conducted to demonstrate feasibility of reducing the theoretical basis behind the DASH methodology to practice, generating a library of predicted particle- and matrix-specific dielectric profiles.

Experimental measurement of complex impedance was set up as described in Example 1, using a commercially available potentiostat.

The following solutions were created and tested over the course of the experiment:
Solution A. Background de-ionized water. De-ionized water was purchased from Sigma Aldrich (St. Louis, US); 300 μL was pipetted into the open-ended coaxial cable.
Solution B. Small red nanospheres mix. 10 μL of 500 nm red fluorescent polystyrene beads (Thermo Fisher Scientific, Watham, MA) were added to 290 μL of de-ionized water and pipetted into the coaxial cable.
Solution C. Large red microspheres mix. 10 μL of 4 μm red fluorescent polystyrene beads (Thermo Fisher Scientific, Watham, MA) were added to 290 μL of de-ionized water and then pipetted into the coaxial cable.

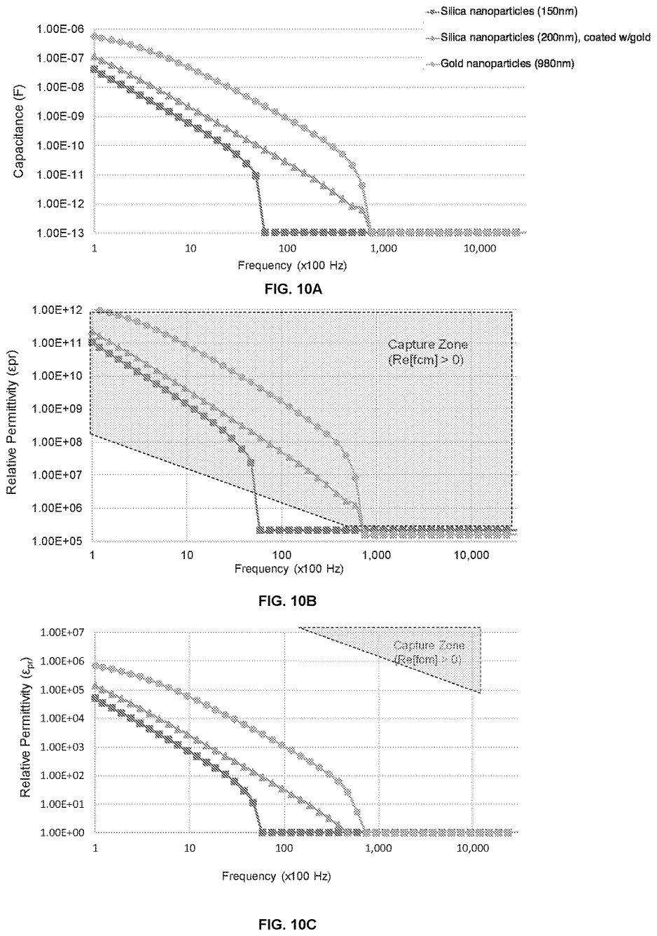

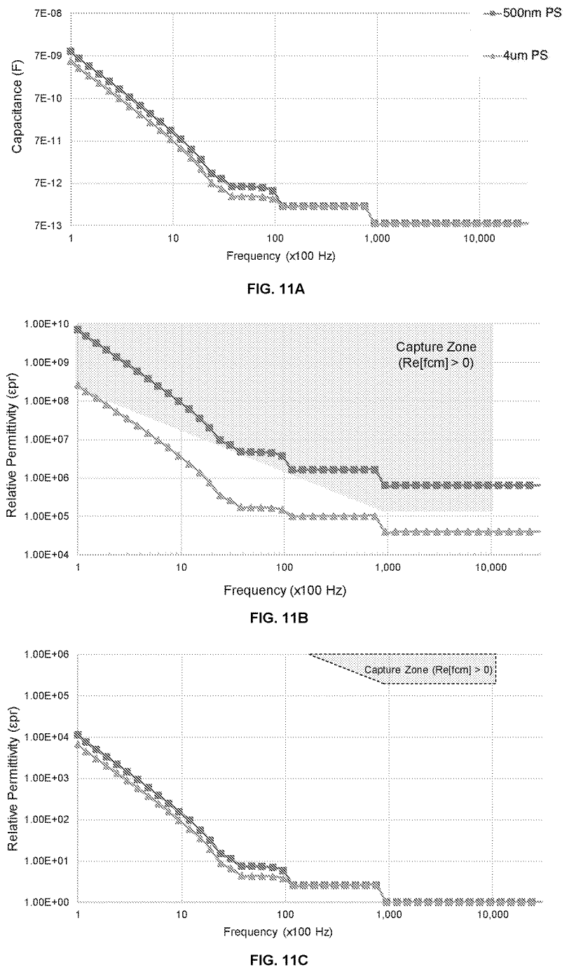

All measurements were taken in triplicate. The measured impedance data was converted into real capacitance as described above in Example 1. Briefly, capacitance of the particles was calculated without the fluid background and with particle-specific parameters to calculate effective permittivity for each of the particles. The resulting capacitance was then plotted in FIG. 11A. The capacitance was also converted to permittivity using the two methods outlined in Example 1 and plotted in FIG. 11B & FIG. 11C respectively.

Method A, as described above in Example 1, was used to generate predictions of particles' permittivity at the same frequency intervals as described above and the particles' resulting charge (positive/negative) in a high ionic strength buffer (100 mM). Shaded areas surrounded by dashed line in FIG. 11B and FIG. 11C outline the predicted “capture zone”, where at the indicated frequencies the particle's permittivity will be sufficient to affect CM to become positive, resulting in particles moving toward the source of electric field.

The experiment demonstrated the feasibility of using experimental data to develop a DASH based predictive isolation profiles for synthetic particles of different size. The experiment also provided an important insight that permittivity is highly dependent on physical size of the particle. FIG. 11A demonstrates that the capacitance of the two particles that are made from the same material but vary vastly in size, is, in fact, nearly identical. However, when particle-specific characteristics are taken in consideration when calculating permittivity via Method A (FIG. 11B), both particles are predicted to have radically different permittivity measurements (and thus vastly different isolation parameters).

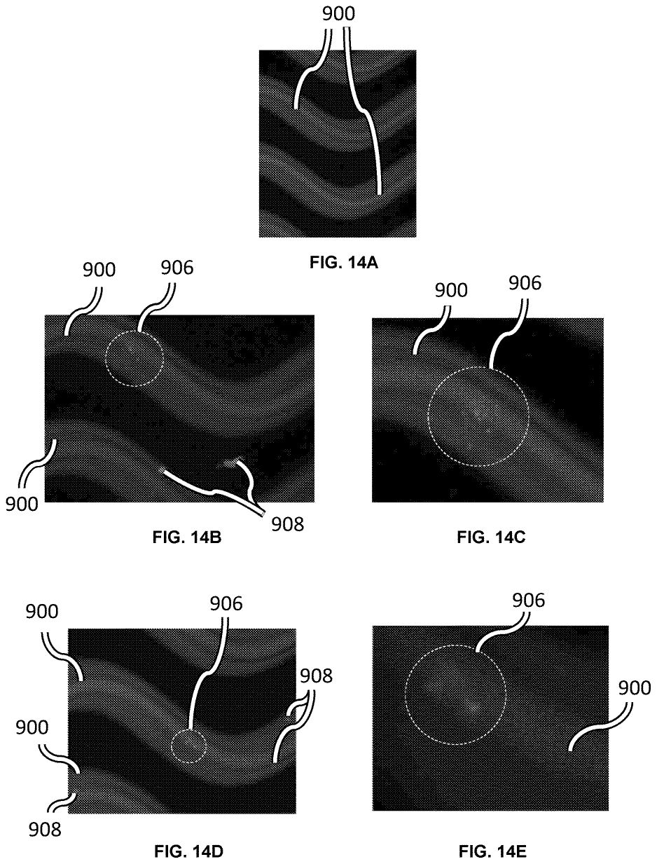

Additionally, this experiment showed that according to current scientific approach to estimating permittivity (FIG. 11C), given the experimental data provided in FIG. 11A, none of these sets of particles would be considered isolatable under high ionic strength/high salt conditions (>10 mM ionic strength). This traditional approach was shown to be incorrect during experiments outlined in Example 5 (results shown in FIGS. 14A-14E), that demonstrates the better than expected performance of the DASH method, as described elsewhere herein, in view of the prior art.

### Example 3. Use of DASH Method to Generate Predictions Library of Particle-Specific Dielectric Profiles for Biological Particles of Different Sizes with and without Modified Membranes

Isolation, separation, and fractionation of biological particles with minimal contamination and sample disturbance is a holy grail of many biomedical applications. This experiment was conducted to demonstrate feasibility of reducing the theoretical basis behind the DASH methodology, as described elsewhere herein, to practice, generating a library of predicted particle- and matrix-specific dielectric profiles for modified and unmodified particles of different sizes.

Experimental measurement of complex impedance was set up as described in Example 1, using a commercially available potentiostat. For the purposes of the experiment, 0.05× Tris Borate EDTA was combined with 250 mM sucrose to maintain osmolar stability in cells (Solution A). In order to demonstrate membrane modifiers used in this experiment: metal (gold) and ceramics (barium titanate) were used. The capacitance and permittivity of the modified particle(s) was compared with the same metrics of the standalone modifiers and unmodified peripheral blood mononuclear cells (PBMCs, size ˜10-16 μm diameter).

The following solutions were created and tested over the course of the experiment:
Solution A. General Background buffer. 300 μL of 0.05× Tris Borate EDTA (Sigma Aldrich, St. Louis, US)+250 mM sucrose.
Solution B. Cell Solution buffer. 10 μL of 1×PBS+290 μL of Solution A, to account for original cell containing buffer in Solution C.
Solution C. Cells in background buffer. 10 μL of peripheral blood mononuclear cells (PBMC) (Human Cell Bio Inc, San Diego, CA)+290 μL of Solution A
Solution D. Ceramic nanoparticles mix. 10 μL of barium titanate (US Research Nanomaterials, Harris County, TX)+290 μL of Solution A
Solution E. Gold nanoparticles mix 10 μL of gold nanoparticles (Barnabas Gold, Kwun Tong, Hong Kong)+290 μL of Solution A
Solution F. Cells coated with ceramic nanoparticles. 10 μL of PBMCs+10 μL of barium titanate+280 μL of Solution A.
Solution G. Cells coated with gold nanoparticles. 10 μL of PBMCs+10 μL of gold nanoparticles+280 μL of Solution A

All measurements were taken in triplicate. The impedance data was converted into real capacitance as described in Example 1. For each particle above, the capacitance of background buffer at given frequency was subtracted from the particle capacitance at that frequency. The resulting capacitance was then plotted in FIG. 12A.

The capacitance was also converted to permittivity using the two methods outlined in Example 1 and plotted in FIG. 12B & FIG. 12C, respectively. Method A, as described in Example 1, was used to generate predictions of particles' permittivity at the same frequency intervals as above and their resulting charge (positive/negative) in a high ionic strength buffer (100 mM). Shaded areas surrounded by dashed line in FIG. 12B and FIG. 12C outline the predicted “capture zone”, where at the indicated frequencies the particle's permittivity will be sufficient to affect CM to become positive, resulting in particles moving toward the source of electric field.

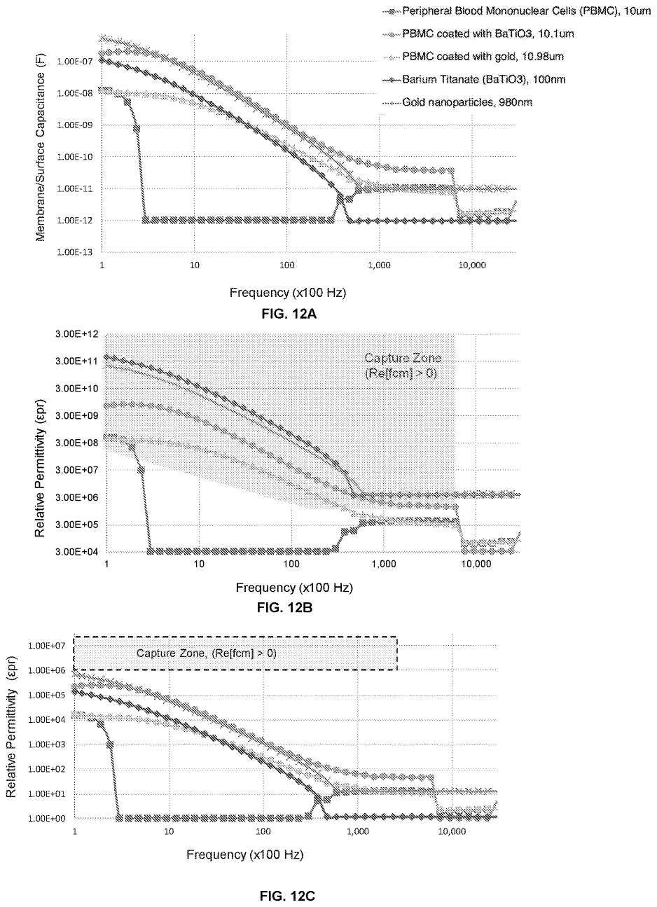

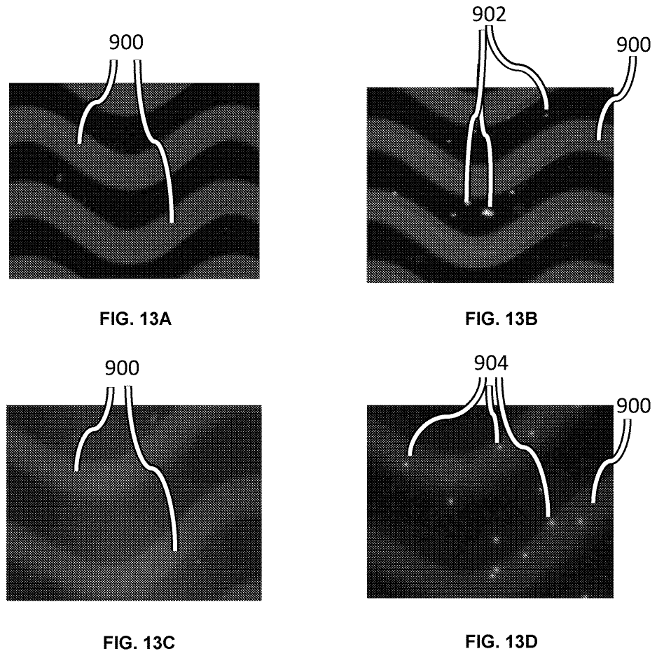

The experiment demonstrated the feasibility of using experimental data to develop a DASH based predictive isolation profiles, as described elsewhere herein, for modified and unmodified biological particles of different size. The experimental data also provides support towards the feasibility of changing effective permittivity of cells by modifying their membrane with inorganic membrane permittivity modifiers (MPM) using highly conductive gold nanoparticles and high dielectric ceramic nanoparticles, as described elsewhere herein. The ability to develop particle-specific isolation profiles and the ability to predict the behavior of particles with and without modifiers validate the performance of the method, described elsewhere herein, for both existing and future biological and biosynthetic particles. Similar to the results outlined in Example 2, under the existing scientific approach to estimating permittivity (FIG. 12C), given the experimental data provided in FIG. 12A, none of the particles tested in this experiment would be considered isolatable under high ionic strength conditions. This traditional approach was shown to be incorrect in experiments outlined in Example 4 & 5 (experimental results shown in FIGS. 13A-13D and FIGS. 14A-14E) below, demonstrating the better-than-expected performance of the DASH method over the prior art.

### Example 4: Isolation of Particles Using Surface Capacitance and Multiple Frequencies-Use of Capacitance Modifiers to Capture What was Previously not Capturable

An experiment was conducted to demonstrate the ability of the methods, described elsewhere herein, to reduce to practice the experimental portion of DASH method. Specifically, whether the predicted isolation ranges determined in Example 3 for modified and unmodified large (greater than about 10 μm) synthetic particles match observed real world experimental results.

A set of several custom microelectrode arrays (Sigil Biosciences, San Diego, CA) were constructed using a metal electrode on a non-conductive surface. The electric field was generated using a HP3145A function generator and delivered to the arrays via gator clips attached to electrical pads that connected to the electrodes 900 seen in FIGS. 13A-13D. The experiments were visualized using a fluorescent microscope (Olympus Corporation of the Americas, Central Valley, PA) set to the Cy5 red channel. Images were captured on a CCD Camera connected to a computer.

The following solutions were created and tested over the course of the experiment:
Solution A. Background buffer. Custom low ionic strength buffer (<10 μM).
Solution B. Unmodified PS microspheres. The 10 μL of 4 μm red fluorescent polystyrene (PS) beads (Thermo Fisher Scientific, Watham, MA) were suspended in 1000 μL of Solution A.
Solution C. Ceramic coated PS microspheres. The 4 μm red fluorescent polystyrene (PS) beads (Thermo Fisher Scientific, Watham, MA)+10 μL of barium titanate (US Research Nanomaterials, Harris County, TX) were suspended in in 1000 μL of Solution A

All measurements were taken in triplicate. Electric field parameters were derived via method outlined in FIG. 11B for unmodified microspheres (Solution B) and FIG. 12B for ceramics coated microspheres (Solution C), with voltage in a range of 5-20 Vp-p and a frequency between 100 kHz-1 MHz. FIG. 13A and FIG. 13C show the electrode arrays in the red fluorescent channel. According to existing scientific approach (see permittivity calculations as seen in FIG. 11C and FIG. 12C), once the electric field is activated, CM will be negative, resulting in particles being repelled by electrodes (900)—to eventually settle in the black spaces between electrodes. This prediction was, indeed, supported by both Method A estimates, our experimental data (unmodified polystyrene beads 902 shown in FIG. 13B), and multiple published experiments.

However, it can be stipulated that the microspheres could be isolatable with the use of synthetic membrane modifiers, such as ceramic nanoparticles, as described elsewhere herein. According to the theory, DASH method, as described elsewhere herein, when the ceramic nanoparticles are used as membrane permittivity modifiers, the ceramic nanoparticles will increase surface capacitance of a particles surface and/or membrane, as described elsewhere herein. This would result in increasing the particle's permittivity and its corresponding isolation range, allowing the particle to be captured under the same electric field parameters as above (voltage from 5-20 Vp-p and frequency between 100 kHz-1 MHz).

The experiment successfully demonstrated both the high utility of the predictive particle behavior library approach and better-than-expected-performance of the DASH method, as described elsewhere herein, in view of the prior art. According to existing scientific approach (see permittivity calculations as seen in FIG. 11C and FIG. 12C), both coated and uncoated microspheres would have had negative CM factors at the >100 KHz frequency range, causing both particles to move away from electrodes 900. To the contrary, as seen in microscope snapshot in FIG. 13D, the modified particles 904 were either captured on the electrode 900 surface or are actively moving towards them.

Previously the generated DASH isolation parameters were used in different experimental conditions, successfully predicting behavior of both unmodified and modified particles. This experiment demonstrated the ability of the methods, described elsewhere herein, to predict and implement controlled isolation of a particle by changing the particles' permittivity.

### Example 5: Isolation of Multiple Sized Particles Using Multiple Frequencies in High Ionic Strength Buffer-Capturing What was Previously not Capturable

The objective of this experiment was to reduce to practice the experimental portion of DASH method, described elsewhere herein, demonstrating our ability to successfully isolate and separate two sets of differently sized particles-first, separately and then simultaneously in the same flow cell using multiple frequencies in moderately high salinity buffers (similar to intracellular fluid) commonly used in biomedical applications. This ability could offer significant advantage to biomedical researchers, allowing for real-time fractionation of precious biological samples, with different particles electro-fluidically separated while leaving the rest of the sample minimally disturbed.

The experimental setup was the same as Experiment 4. New custom manufactured microelectrode array (Sigil Biosciences, San Diego, CA) was used for this experiment.

The following solutions were created and tested over the course of the experiment:
Solution A. Background Buffer. 1× Tris Borate EDTA (1×TBE) Sigma Aldrich, a high ionic strength buffer (10 mM)
Solution B. Small red nanospheres mix. 10 μL of 500 nm red fluorescent polystyrene beads (Thermo Fisher Scientific, Watham, MA) were added to 1000 μL of Solution A.
Solution C. Large red microspheres mix. 10 μL of 4 μm red fluorescent polystyrene beads (Thermo Fisher Scientific, Watham, MA) were added to 1010 μL of Solution B.

All measurements were taken in triplicate. Electric field parameters were derived via method outlined in FIGS. 11B, 12B and 13B, as predicted by Equation 2 and applied to the array as following: 5-20 Vp-p with a frequency sweep between 10 kHz-100 kHz (Interval 1) and 1 kHz-10 kHz (Interval 2). FIG. 14A shows the microelectrode array 900 prior to the application of the electric field to the electrodes.

At the above frequencies (both Intervals 1 and 2), under traditional permittivity estimates (FIG. 11C), both the 4 μm and 500 nm particles suspended in Solution B should have negative CM factor and be repulsed away from the electrodes. Equation 2, however, predicts that at Interval 1, only large 4 μm particles should be repulsed while the 500 nm nanoparticles will be captured on the electrodes. As observed in FIG. 14B, 500 nm particles 906 were indeed captured on the electrodes 900, while the 4 μm polystyrene beads 908 were repulsed and settled in between the electrodes. A zoomed-in image of the 500 nm particles 906 captured on the electrodes 900, is shown in FIG. 14C.

The frequency was then swept within Interval 2, at which Equation 2 predicts and FIG. 11B explains that at interval 2, both sets of particles suspended in Solution B should go positive, and that is precisely what is observed. FIG. 14D shows both the 500 nm polystyrene particles 906, and the 4 μm polystyrene particles 908 were captured on the surface of the electrodes 900. A zoomed-in image of the 500 nm particles 906 captured on the electrodes 900 is shown in FIG. 14E.

This experiment demonstrated our ability to successfully isolate and separate two sets of differently sized particles-first, separately and then simultaneously in the same flow cell using multiple frequencies. Notably, the particles were isolated from a buffer with ionic strength that was matching intracellular fluid, providing feasibility data for isolating naturally occurring biological particles of similar sizes as well, as described elsewhere herein. This experiment and the results obtained provide significant implications about flexibility of using DASH method, as described elsewhere herein, for real-time fractionation of samples with different particles sizes that may be separated and eluted while leaving the rest of the sample minimally disturbed.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention.

Although the steps or elements of the method, shown and described elsewhere herein, are described in a particular order, the steps may be completed in a different order. Steps may be added or omitted. Some of the steps may comprise sub-steps. Many of the steps may be repeated as often as beneficial.

It is therefore contemplated that the invention shall also cover any such alternatives, modifications, variations, or equivalents. It is intended that the following claims define the scope of the invention and that methods and structures within the scope of these claims and their equivalents be covered thereby.

### Definitions

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

“High dielectric constant” as referred to elsewhere herein, refers to a range of dielectric constants (i.e., relative permittivities) determined by methods described in Equation 2 or a traditional approach to measure the dielectric constant of one or more particles. The range or values of the dielectric constant, as described elsewhere herein, may indicate a range of “high dielectric constants” based on the frequency used to measure the dielectric constant. For example, “High dielectric constants” may refer to a relative permittivity of a particle of at least about 100,000 when measured with Equation 2 at 1 kHz frequency. “High dielectric constants” may also refer to a relative permittivity of at least about 1000 when measured by a traditional method at 1 KHz.

Certain inventive embodiments herein contemplate numerical ranges. When ranges are present, the ranges include the range endpoints. Additionally, every sub range and value within the range is present as if explicitly written out. The term “about” or “approximately” may mean within an acceptable error range for the particular value, which will depend in part on how the value is measured or determined, e.g., the limitations of the measurement system. For example, “about” may mean within 1 or more than 1 standard deviation, per the practice in the art. Alternatively, “about” may mean a range of up to 20%, up to 10%, up to 5%, or up to 1% of a given value. Where particular values are described in the application and claims, unless otherwise stated the term “about” meaning within an acceptable error range for the particular value may be assumed.

What is claimed is:

1-120. (canceled)

121. A method of isolating particles, the method comprising:
providing a device comprising at least one chip, the at least one chip comprising at least one electrode and at least one substrate, the at least one electrode and the at least one substrate being configured to produce an electric field on or around the substrate when a current is applied to the at least one electrode;
providing a fluid composition comprising one or more particles;
modifying a particle permittivity or a membrane permittivity of the one or more particles by applying the electric field; and
isolating the one or more particles based on the particle permittivity or membrane permittivity.

122. A method of isolating particles, the method comprising:
providing a fluid composition comprising one or more particles, each having a membrane on a surface of the one or more particles;
modifying a membrane permittivity of the one or more particles by attaching to, coating, or introducing into the membrane at least one modifier;
providing a device comprising at least one chip, the at least one chip comprising at least one electrode and at least one substrate, the at least one electrode and the at least one substrate being configured to produce an electric field on or around the substrate when a current is applied to the at least one electrode;
introducing the fluid composition into the device; and
isolating the one or more particles based on the membrane permittivity of the one or more particles.

123. The method of claim 121, wherein applying the electric field generates electro strictive hydrodynamic forces that act to isolate the one or more particles.

124. The method of claim 123, wherein the electro strictive hydrodynamic force comprises electrophoretic force, electrokinetic force, interfacial polarization, electro strictive force, alternating current (AC) electrothermal force, or any combination thereof.

125. The method of claim 124, wherein the one or more particles comprise a plurality of first particles and a plurality of second particles, and the method further comprises, after providing the fluid composition, selecting a first frequency specific to the plurality of first particles and a second frequency specific to the plurality of second particles.

126. The method of claim 125, wherein the first frequency and the second frequency are in a range from about 100 Hz to about 1 MHz.

127. The method of claim 125, wherein the first frequency and the second frequency are in a range from about 1 MHz to about 20 MHz.

128. The method of claim 125, wherein the plurality of first particles and the plurality of second particles comprise naturally occurring bioparticles, biosynthetic particles, synthetic particles, or a combination thereof.

129. The method of claim 125, wherein the plurality of first particles and the plurality of second particles have different sizes or same sizes.

130. The method of claim 125, wherein the first plurality of particles or the second plurality of particles comprises particles enwrapped by a surface membrane shell made of the same material as the core, a polymer membrane, a lipid membrane, or a combination thereof.

131. The method of claim 121, wherein modifying a particle permittivity or a membrane permittivity of the one or more particles comprises modifying a capacitance of the one or more particles.

132. The method of claim 121, further comprising modifying a membrane permittivity of the one or more particles by attaching to, coating, or introducing into the membrane at least one modifier, wherein the at least one modifier comprises one or more membrane-permittivity modifiers.

133. The method of claim 132, wherein the membrane-permittivity modifiers comprises a material selected from the group consisting of a protein, a lipid, a biopolymer, a naturally occurring polymer, a synthetic polymer, a conjugated polymer, a ceramic, a metal, and combinations thereof.

134. The method of claim 132, wherein the one or more membrane-permittivity modifiers are present as a coating on the membrane, nanoparticle attachment on the membrane, as an integral component of the membrane, or as a transmembrane element.

135. The method of claim 132, further comprising reversing the modification of the membrane permittivity of the particles, wherein the reversing is effected by heat, by an enzyme, or by a combination thereof.

136. The method of claim 121, further comprising analyzing the isolated one or more particles on the chip or quantifying the isolated one or more particles.

137. The method of claim 131, wherein the particle permittivity of the one or more particles is a relative permittivity of the one or more particles.

138. The method of claim 121, further comprising eluting the isolated one or more particles from the chip for downstream analysis.

139. The method of claim 138, wherein eluting the isolated one or more particles comprises eluting each of the one or more particles sequentially from the chip.

140. The method of claim 138, further comprising analyzing the isolated particles to generate data, and using the data to construct high high-resolution computational models of cells, cellular or subcellular interactions for applications including computational disease modeling, digital compound testing, drug candidate selection, prediction of adverse events, or other computational approaches.
